(19) United States
(12) Patent Application Publication
(10) Pub. No.: US 2003/0059025 A1
(43) Pub. Date: Mar. 27, 2003

(54) Multi-media communication management system supporting selectable appliance modules

(75) Inventors: Robert F. Meyerson, Naples, FL (US); Calvin E. Lewis, Copley, OH (US)

Correspondence Address: TIMOTHY P. O'HAGAN, 8710 KILKENNY CT, FORT MYERS, FL, 33912, US

(73) Assignee: Teleware, Inc., Akron, OH

(21) Appl. No.: 10/097,217

(22) Filed: Mar. 13, 2002

Related U.S. Application Data
(63) Continuation-in-part of application No. 09/961,532, filed on Sep. 24, 2001.
(63) Continuation-in-part of application No. 10/000,543, filed on Oct. 23, 2001.

(51) Int. Cl. H04M 7/00; H04M 11/00

(52) U.S. Cl. 379/220.01; 379/88.13

(57) ABSTRACT

The multi-media communication management system comprises a controller that interfaces with a plurality of communication space stations and with one or more communication medium service providers. The communication space stations include docking bays for coupling to a selected appliance module. The controller includes a local content server for providing information content that is compatible with the subscriber interface of a modular appliance. The communication space station provides for translation of information content between the information content server and the appliance module.

### CROSS REFERENCE TO RELATED APPLICATIONS

The present application is a continuation in part of U.S. patent application Ser. 09/961,532 titled Teledata Space and Docking Station with Modular and Integrated Display filed on Sep. 24, 2001, and is a continuation in part of U.S. patent application Ser. No. 10/000,543 filed on Oct. 23, 2001, titled Modular Multi-Media Communication Management System, the contents of both such patent applications is incorporated herein.

### TECHNICAL FIELD

The present invention relates generally to managing multi-media communications, and more particularly to a modular system with selectable appliance modules, each of which includes a subscriber interface optimized for providing a type of information to the subscriber.

### BACKGROUND OF THE INVENTION

In today's fast paced business world, it is common for a person to rely on a combination of communication devices, such as: desk top telephones, mobile telephones, cellular telephones, fax machines, pagers, radios, televisions, Internet connected computers, and the like, to accommodate their information and communication needs.

In an office environment, desk top telephone service, voice mail service, and fax service is typically provided by a private telephone communication system. A contemporary private telephone communication system consists of a switching network, a plurality of desktop telephones, and a voice mail server. The voice mail server is typically coupled to the switching network using a proprietary interface. Each desk top telephone and fax machine is coupled to the switching network by an extension line that consists of twisted pair conductors that are terminated by a telephone jack in the office. Communication between the desktop telephone and the switching network over each extension line utilizes either proprietary digital signaling or plain old telephone service (POTS) signaling. The switching network is further coupled to the public switched telephone network (PSTN) using trunk lines that are connected to a central office switch that is typically managed by the local telephone service provider. The switching network controls calls between extensions and between an extension and a remote destination via a trunk line coupled to the PSTN. The switching network also routes calls to the voice mail server when an extension remains unanswered, is busy, or is otherwise programmed to route calls to voice mail.

Recently fixed wireless networks have enabled wireless mobile telephones to be supported by the private telephone communication system. A wireless telephone controller is coupled to a wireless network in which a plurality of mobile telephones may be operated. The wireless telephone controller is coupled to the switching network of the private telephone communication system. In operation, each mobile telephone is assigned an extension number and calls directed to that extension are routed to the wireless telephone controller and then to the mobile telephone over the wireless network. Because the mobile telephone is equivalent to a desktop telephone from the perspective of the private telephone communication system, full voice mail services are supported for the mobile telephone.

Internet information services are typically provided by a plurality of content service providers coupled to the Internet and are typically accessed by client software on the person's desktop and/or notebook computer. Internet information may include messaging services such as email and may include information services that provide news reports, stock prices, or other information content available on the web. The information content may be in the form of HTML documents or in the form of real time streaming audio or audio/video files.

A problem associated with utilizing a desk top or notebook computer for Internet information is that the generic user interface of the computer, keyboard, and browser software is adequate for the display of HTML documents, but is not optimized for display of real time audio/video information and is not optimized for the subscriber to interact with the service provider using intuitive and dedicated buttons or other controls.

Another problem associated with using a telephone system for some information and communication services and utilizing the desktop or notebook computer for other information services is that there is a lack of integration and coordination between the services.

What is needed is a multi-media communication management system that provides coordinated and integrated access to communication services and information content that does not suffer the disadvantages of existing communication systems.

### SUMMARY OF THE INVENTION

The multi-media communication management system comprises a controller that interfaces with a plurality of communication space stations, and their associated subscriber device(s), and with one or more communication medium service providers.

The controller translates multi-media communications received from a multimedia service provider into the protocols required for use by the communication space stations as well as any conventional telephone stations that may be coupled to the controller. The communication and control signaling between the controller and the communication space stations may be wireless in nature with the communication space stations may each be powered by an internal battery and/or connection to a local source of conventional line power.

The architecture of the communication space station is modular. Multiple functional elements can be interconnected with backbone communication circuitry to form an integrated communication platform. Modular docking interfaces may be used to couple the space station communication device to portable subscriber devices and to appliance modules that have a user interface optimized for specific communication and/or information services. The communication space station integrates and coordinates communication through multiple communication medium service providers. This coordinated and integrated system architecture enables the space station communication device to merge the functionality and internal data of the various portable subscriber devices and appliance modules into the space station communication device, to direct the functionality and data of the space station communication device to a selected one of the portable subscriber devices, and to provide the subscriber with a simple subscriber interface.

For a better understanding of the present invention, together with other and further aspects thereof, reference is made to the following description, taken in conjunction with the accompanying drawings, and its scope will be pointed out in the appended clams.

### BRIEF DESCRIPTION OF THE DRAWINGS

FIG. 1 is a block diagram view of a modular multi-media communication management system in accordance with one embodiment of the present invention;

FIG. 2 is a block diagram of a multi-media communication management system controller in accordance with one embodiment of the present invention;

FIG. 3 is a perspective exploded view of a modular communication space station in accordance with one embodiment of the present invention;

FIG. 4 is a block diagram of a communication space station in accordance with one embodiment of the present invention;

FIG. 5 is a block diagram of a subscriber data assistant in accordance with one embodiment of the present invention;

FIG. 6 is a block diagram of a wide area network communication device in accordance with one embodiment of the present invention;

FIG. 7 is a block diagram of a wireless dialog handset in accordance with one embodiment of the present invention;

FIGS. 8a is a table diagram representing a current network location table in accordance with one embodiment of the present invention;

FIG. 8b is a table diagram representing a multicast group table in accordance with one embodiment of the present invention;

FIG. 9 is a block diagram of a first exemplary appliance module in accordance with one embodiment of the present invention;

FIG. 10 is a block diagram of a second exemplary appliance module in accordance with one embodiment of the present invention;

FIG. 11 is a block diagram of a third exemplary appliance module in accordance with one embodiment of the present invention;

FIGS. 12a through 12j each show a flow chart representing processing steps performed by a multi-media communication management application in accordance with one embodiment of the present invention;

FIG. 13 is a flow chart representing processing steps performed by an exemplary content application in accordance with one embodiment of the present invention;

FIG. 14 is a flow chart representing processing steps performed by a module support application in accordance with one embodiment of the present invention;

FIG. 15 is a flow chart representing exemplary operation of packet audio/video gateway in accordance with one embodiment of the present invention; and

FIGS. 16a through 16f each show an exemplary display of information to a subscriber utilizing a subscriber interface of a communication space station in accordance with one embodiment of the present invention; and

### DESCRIPTION OF THE PREFERRED EMBODIMENTS

The present invention is now described in detail with reference to the drawings. In the drawings, each element with a reference number is similar to other elements with the same reference number independent of any letter designation following the reference number.

It should also be appreciated that many of the elements discussed in this specification may be implemented in hardware circuit(s), a processor executing software code, or a combination of a hardware circuit and a processor executing code. As such, the term circuit or module as used throughout this specification is intended to encompass a hardware circuit (whether discrete elements or an integrated circuit block), a processor executing code, or a combination of a hardware circuit and a processor executing code, or other combinations of the above known to those skilled in the art.

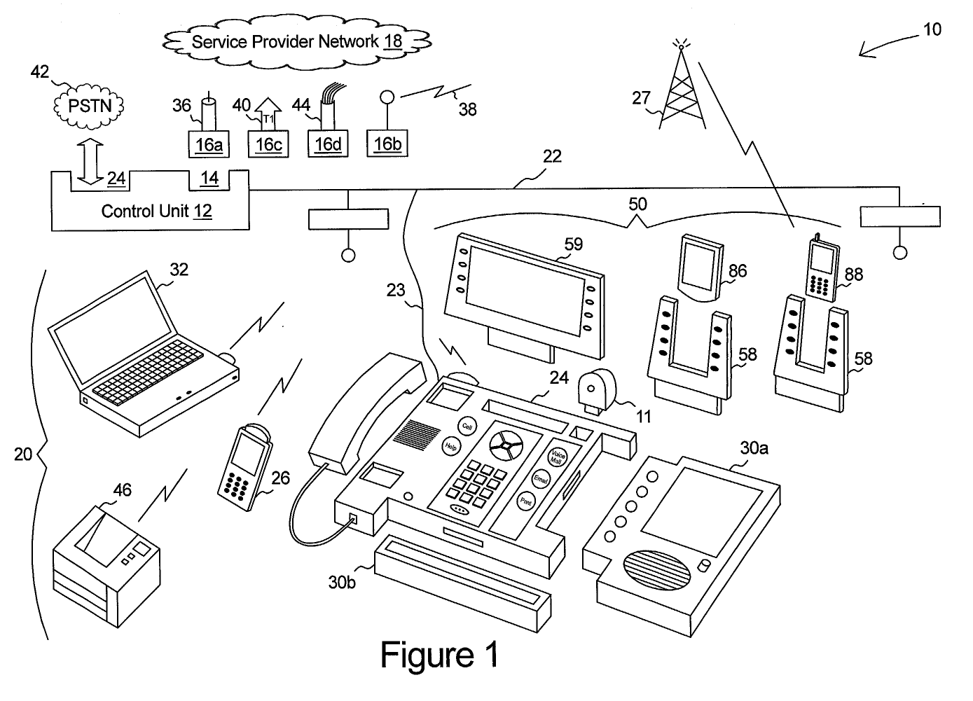

Referring to FIG. 1, an exemplary architecture of the multi-media communication management system 10 of the present invention is shown. The multi-media communication management system 10 includes a control unit 12 that is coupled with a plurality of local communication devices 20 over a wireless local area network 22 (or by a wired network connection 23 to the backbone wired network of the wireless local area network 22). The local communication devices 20 may include: subscriber stations 24 (communication space stations 24), wireless dialog handsets 26, traditional computer systems 32, and network printers 46. Each subscriber station 24 may include multiple module docking bases 62a, 62b, and 62c for supporting various appliances and subscriber devices that may include data appliance modules 30a and 30b, a display screen 59, or a docking interface module 58 which in-turn supports a subscriber device such as a personal data assistant 86 or a wireless telephone appliance 88.

Appliance modules 30a and 30b may each include a user interface and circuitry tailored to facilitate user interaction and/or display of a particular type of data to a subscriber. For example, appliance module 30 a includes a long and narrow display screen and circuits tailored to present a streaming stock ticker display. Appliance module 32b includes a display, speaker, volume control, channel select buttons, and circuits tailored to display streaming audio/video new or other programming from subscriber selected sources.

The control unit 12 includes a circuit switched provider bay 24 which operatively couples the control unit 12 to one or more subscriber loops of the public switched telephone network (PSTN) 42 and includes a multi-media communication service provider bay 14 which operatively couples the control unit 12 to a multi media service provider's network 18 through one of a plurality of communication medium modules 16a-16d.

In the exemplary embodiment, the service provider's multi-media communication network 18 may utilize the Internet Protocol Suite for communication at the IP level, but may be proprietary at the data link and physical layers. As such, the control unit 12 includes the IP stacks applicable for communication between applications over the network 18 and each module 16a-16d includes the applicable data link and physical layer circuits for communication of IP frames over the physical medium of the network 18a-18d.

Some illustrative examples of communication modules include: communication module 16a which may be a cable modem module for communicating over coaxial cable 36 with a multi-media communication service provider such as a local cable company, communication module 16b which may be a wide area network radio for communication over a wireless spectrum channel 38 with a wide area wireless multi-media communication service provider such as an analog or digital cellular/PCS telephone service provider, communication module 16c which may be a customer service unit (CSU) for communication over a T1 line 40 with a multi-media communication provider such as a local telephone service provider, and communication module 16d which may be an optical modem for communication over a fiber channel 44 with a fiber optic multi-media communication service provider.

In operation, the control unit 12 integrates and manages multi-media communication between two or more local communication devices 20 and between each local communication device 20 and a remote communication system(s) (not shown) coupled to either the service provider's multi-media communication network 18 or the PSTN 42.

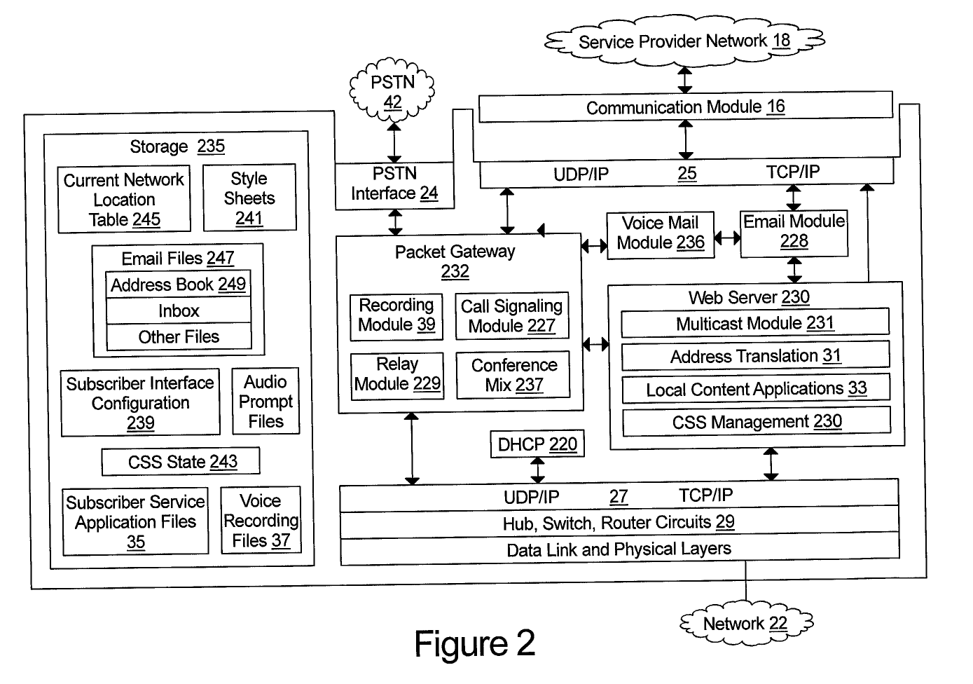

Referring to FIG. 2, the control unit 12 includes applicable modules for managing the local area network 22 as an IP network. Such modules may include an applicable combination of hubs, routers, and switches 29 for managing communications over the network 22 as well as an address server 220 (e.g. DHCP server) for assigning local IP addresses to each local communication device 20.

The control unit 12 may also include a packet audio/video gateway 232, a voice mail module 236, an email module 228, a web server 34, a PSTN interface 24, and a storage 235.

Packet Voice Gateway

The packet audio/video gateway 232 provides a subscriber's real time full duplex audio communication and audio/video communication services. The services may include routing, maintaining, and selectively recording a subscriber's outgoing calls and incoming calls. A subscriber's outgoing calls may comprise audio calls, audio/visual calls, and multiparty conference calls (either audio or audio/visual) that are originated by a communication space station 24 that is associated with the subscriber. The destination(s) may include remote packet audio/video devices coupled to the network 18, remote telephones coupled to the PSTN 42, or other subscriber's served the multi media communication management system 10. A subscriber's incoming calls may comprise calls (either audio or audio/visual) that are originated by a remote telephone device coupled to the PSTN 42, remote packet audio/visual devices coupled to the network 18, communication space stations 24, or the audio/visual conference module 229 and that identify the subscriber as the destination subscriber.

The packet audio/video gateway 232 communicates over the network 22 and the network 18 utilizing IP protocols. However, audio communication over the PSTN 42 utilizes analog or PSTN digital audio signals. As such, the PSTN interface 24 includes circuits for translating between PSTN call signaling (and analog/digital PSTN audio communication) to digital call signaling messages (and digital audio communication) for use by the packet audio/video gateway 232. Therefore, for the sake of simplicity, the discussion of the packet audio/video gateway 232 herein will refer to PSTN interface 24 as an originating or destination device with which an audio call may be established and maintained. However, it should be appreciated that the PSTN interface 24 is not the ultimate origination or destination but is operating to interface the packet audio/video gateway 232 to a telephone system on the PSTN 42 with which it could not communicate directly.

The packet audio/video gateway 232 includes a call signaling module 227. The call signaling module 227 includes circuits for receiving call signaling messages from an originating device, identifying a destination device, providing call signaling messages to the destination device, and, if responded to by the destination device, negotiating compression algorithms and establishing channel usage for the relay of real time audio or audio/visual communications. In the exemplary embodiment call signaling utilizes defined protocols such as the H.323 protocols promulgated by the International Telephony Union (ITU) or the Session Initiation Protocols (SIP) promulgated by the Internet Engineering Task Force (IETF).

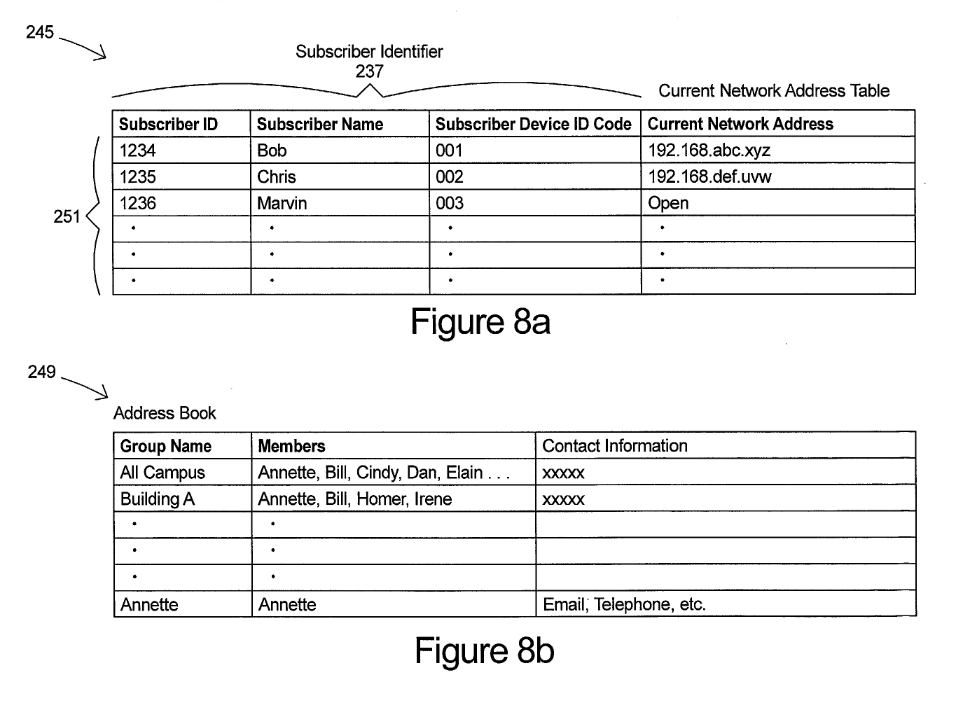

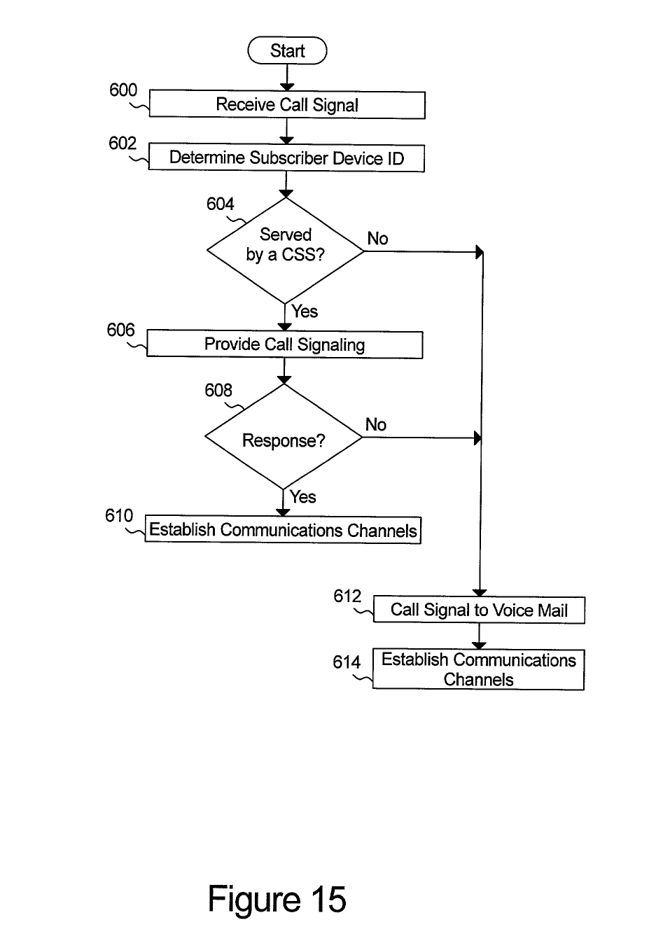

For inbound calls, the call signaling message provided by the originating device may identify a subscriber served by the multimedia communication management system 10. The call signaling module attempts to identify the communication space station 24 that is then serving the subscriber device 50 that is assigned to the identified subscriber. Referring to FIG. 15 in conjunction with the current network location table 245 of FIG. 8a, the process of identifying a destination device is shown.

Step 600 represents receipt of the call signaling message identifying the subscriber. In the exemplary embodiment, each subscriber will be assigned a four digit subscriber identifier number that corresponds to the last four digits of a PSTN direct dial number that routes to the PSTN interface 24 when dialed on the PSTN. As such, the call signaling message, whether provided by an originating device coupled to network 18, an originating device coupled to network 22, or the PSTN interface 24, may include the subscriber identifier number to identify the destination subscriber.

At step 602, the call signaling module identifies a subscriber device 50 (FIG. 1) that is associated with the identified subscriber utilizing the network location table 245. To associate each subscriber with his or her subscriber device 50, the network location table 245 includes a record for each subscriber. Within such record is a field that identifies the subscriber, identifies the four digit subscriber identifier associated with the subscriber, and identifies a subscriber device ID code that is unique to the subscriber device 50 that is assigned to the subscriber.

At step 604 the call signaling module identifies whether the subscribers subscriber device 50 is served by a communication space station. The network location table 245 further includes a field that may comprise the network address of the communication space station 24 that is then currently serving the subscriber device 50 assigned to the subscriber. The address within this field will be updated when the subscriber moves his or her subscriber device 50 from one communication space station 24 to another using circuits and methods discussed herein. If the subscriber device is not currently served by any communication space station 24, then the field will indicate such as represented by the term “open”.

If at step 604, the call signaling module determines that the subscriber device 50 assigned to the subscriber is not currently served by any communication space station 24, the voice mail module 236 becomes the default destination device to which call signaling is provided at step 612. However, if the subscriber device is served by a communication space station 24, such communication space station becomes the destination device to which call signaling is provided at step 606.

Step 608 represents the call signaling module determining whether the communication space station 24 is responding to the call signaling. In certain events such as when the subscriber is already engaged in a telephone call or if the subscriber does not answer the inbound call, the communication space station 24 will not respond to the call signaling. In which case, the voice mail module 236 will again become the default destination device to which call signaling is provided at step 612.

If the call signaling is responded to by the communication space station 24, the call signaling module will negotiate compression algorithms and establish communication channels with both the communication space station 24 and with the originating device to relay audio or audio/visual real time communications for the duration of the call.

If call signaling is provided to the voice mail module 236 at step 612, the call signaling module will negotiate compression algorithms and establish communication channels only to the originating device to relay audio real time communications between the voice mail module 236 and the originating device until the originating device is disconnected from the voice mail module.

Returning to FIG. 2, for outbound calls, the call signaling module may be provided with a number that represents the intended destination. The number may be a 10 digit number routable on the PSTN, a number identifying a person or station coupled to the network 18, or a subscriber ID representing a subscriber to the system 10. The call signaling module may identifying the destination device first by determining whether the number represents a person or destination coupled to the network 18, the PSTN routable telephone number, or a subscriber. The call signaling module may refer to a directory within storage 235 that maps possible numbers to one of the three networks. It should be appreciated that a PSTN routable telephone number may also represent a person or station coupled to the network 18. As such, the directory within storage 235 may include a priority such that the call signaling model will attempt to establish call signaling utilizing network 18 as a first priority and the PSTN 42 as a second priority.

If the destination device is coupled to the network 18, the number may be permanently assigned to a person or a station, however, the IP network address utilized by the person or station may change periodically. As such, the call signaling module may query a remote directory server to determine the network address of the destination device or the network address of a proxy for the remote device. Call signaling is then provide to the destination device or the proxy. If the call signaling is responded to by the proxy or the remote device, the call signaling module will negotiate compression algorithms and establish communication channels with both the originating communication space station 24 and with proxy or remote device for the relay of audio or audio/visual real time communications for the duration of the call.

If the destination device is coupled to the PSTN 42, the destination device is the PSTN interface 24 and call signaling is provided to the PSTN interface 24. Again, if the call signaling is responded to by the PSTN interface 24 (indicating that the call has been established on the PSTN 42) the call signaling module will negotiate compression algorithms and establish communication channels with the originating communication space station 24 for the relay of real time audio communications between the communication space station 24 and the PSTN interface 24 for the duration of the call.

If the destination device is a subscriber to the system 10, steps discussed above with respect to FIG. 15 are applicable.

For both inbound and outbound calls, the relay of real time audio or audio/video communications is provided by a relay module 229 within the packet audio/video gateway 232. The relay module 229 relays sequences of real time transport protocol (RTP) frames that include compressed audio data and compressed video communications between each of the call participants and the conference mix module 237. The conference mix module 237 includes audio mixing circuits for receiving multiple audio streams to generate one or more conference mix audio streams. The conference mix module 237 provides the conference mix audio streams back to the relay module 229 for relay back to the conference session participants. It should be appreciated that it is undesirable to include the voice of a participant in the conference mix audio stream that will be returned to such participant because echoes could occur. As such, a single conference call may require multiple conference mix audio streams—one for each participant that excludes such participant's own voice. As such, the conference mix module 237 may also generate a master mix signal that includes all participants that is passed to the recording module 39 which, in turn, stores a digital representation of the master mix signal in a voice recording file 37.

Voice Mail Module

The voice mail module 226 includes circuits for responding to the call signaling provided by the call signaling module 227, providing a sequence of RTP frames representing applicable audio prompts from compressed audio prompt files 233 to the relay module 229, receiving RTP frames from the relay module 229 representing the voice of the remote caller leaving a message for the subscriber, compressing the message into a digital audio file, and sending the digital audio file to the email module 228 for storage in the email files 247 for later retrieval by the subscriber.

Email Module

The email module 228 maintains an email account associated with each subscriber. The email module 228 includes circuits for interfacing with a remote email server. The email module 228 logs onto an account associated with each subscriber, obtains new email messages associated with the subscriber, and sends email messages drafted by the subscriber to the remote server. The email module 228 also maintains email files 247 in the storage 235 that may include an address book and an inbox for each subscriber.

Web Server

The web server 34 comprises a communication space station management application 230, a multicast module 231, an address translation module 31, and a local content application 33. Examples of the multi media communication services provided to each subscriber by the web server 34 include: a) delivery of email and voice mail messages (as emailed audio files) to the communication space station 24 at which the subscriber's subscriber device 50 is then currently coupled; b) updating of the network location table 245 to assure proper routing of incoming audio and audio/video calls; c) delivery of data content provided by local data applications; d) proxy communication over network 18 for delivery of data content provided by remote data application providers; e) delivery of a multicast messages directed to a subscriber to the particular communication space station 24 at which his or her subscriber device is then currently coupled; and f) providing subscriber control of audio and audio/video conference calls through the packet voice gateway 232.

To provide communication services to each communication space station 24, the communication space station management application 230 processes certain scripts in response to events generated by a communication space station 24 and the packet audio/video gateway 232. In processing the scripts, the communication space station management application 230 manages subscriber communication data stored in a storage 235 and provides operating instructions to each communication space station 24, the email module 228, the multicast module 231, and the local content application 33. The communication space station management application 230 provides for the communication space station 24 to navigate, as a client, through a layered menu to select applicable services from the control unit 12. The communication space station application 230 maintains state information for each communication space station 24 such that each communication space station 24 may navigate through the layered menu independently of other communication space station 24 units. A more detailed discussion of the operation of the communication space station management application 230 is included herein.

The multicast module 231 provides IP multicast services to enable the communication space station management application 230 to deliver select communication services to multiple communication space stations 24 simultaneously utilizing IP multicast protocols and without using excessive bandwidth on network 22.

The address translation module 31 provides address and port translation services to enable the web server to provide each communication space station 24 with access to servers that provide remote data applications and are coupled to the network 18 as an IP layer proxy and without using higher layer resources of the control unit 12.

The local data content application 33 provides data content to each communication space station 24 in accordance with subscriber interaction through the communication space station 24. A more detailed discussion of an exemplary local data content application 33 is included herein.

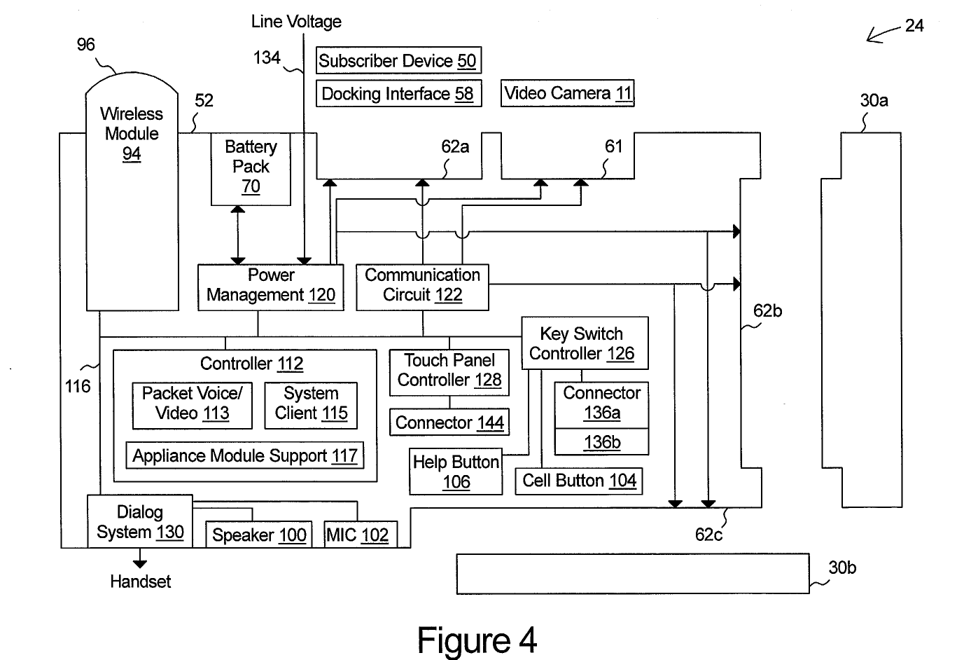

In the exemplary embodiment, non streaming media communication between the web server 34 and each communication space station 24 utilizes tagged data messages over a TCP/IP session between the web server 34 and a system client application 115 or an appliance module support application 117 (FIG. 4) within the communication space station 24. Each message transferred between the web server 34 and the communication space station 24 comprises a data element and a tag identifying the significance of the data element. For example: a) if the data element comprises the text of an email message, the tag would identify the data element as the text of an e-mail message; b) if the data element comprises an executable script that would provide for the communication space station 24 to perform a certain function, the tag would identify the data element as executable script and may identify the significance of the script; and c) if the data element comprises display layout control information (e.g. a style sheet) defining how another date element (such as the text of the email) should be displayed on a display screen, the tag would identify the data element as a style sheet.

Streaming media communications between the web server 34 (such as multicast streaming media messages provided by the IP multicast module 231 or streaming media content provided by the address translation module 31 or the local data application 33) and the client application 115 or the appliance module support application 117 utilize a sequence of RTP frames that include compressed media data and are sent utilizing UDP/IP channels.

Communication Space Station

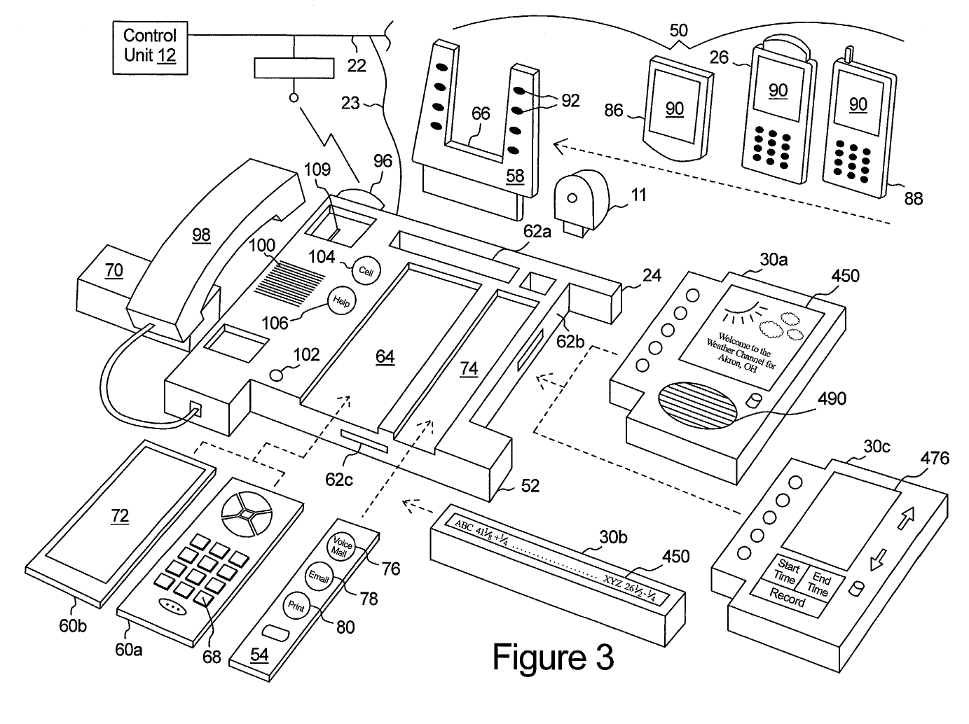

Referring to FIG. 3, a perspective view of an exemplary communication space station 24 is shown. The communication space station 24 includes a platform unit 52 that operatively couples to the control unit 12 via either a wireless communication link between a platform unit network circuit 96 and the wireless network 22 or a direct network connection 23 between the platform unit 52 and the backbone network of the wireless network 22.

A plurality of subscriber interface modules 54, 60a, 60b, and 11 may be coupled to the platform unit 52. The platform unit 52 includes a subscriber interface docking platform 64 for coupling and optionally supporting one of a plurality of modular subscriber interface units 60a or 60b to the platform unit 52. The modular subscriber interface unit 60a may include a plurality of buttons 68 in an arrangement similar to a typical telephone key pad to provide for subscriber input in a manner similar to that of a traditional telephone handset. The modular subscriber interface 60b may include a touch panel graphic display 72 to provide for subscriber input through virtual buttons visible thereon.

The platform unit 52 further includes a subscriber interface docking platform 74 which couples to a subscriber interface modules 54. In the exemplary embodiment, the subscriber interface module 54 may include subscriber interface buttons configured for enhancing subscriber messaging through the communication space station 24 such as a voice message control 76 for single button access to voice message files, an email control 78 for single button access to subscriber email messages, and a print control 80 for single button initiation of the printing of an email message.

The platform unit 52 further includes a docking bay 62a into which a modular docking interface 58 may be secured and operatively coupled to the platform unit 52. The modular docking interface 58 supports one of a plurality of modular subscriber devices 50 within a subscriber device interface bay 66 and provides for operatively coupling the modular subscriber device 50 to the platform unit 52. Exemplary configurations for the modular subscriber device 50 include a subscriber data assistant 86, a subscriber wide area network communication device 88, and the wireless LAN voice handset 26, each of which is discussed in more detail herein.

The platform unit 52 also includes docking bay 61 into which a modular video camera 11 may be coupled to the communication space station 24.

The platform unit 52 also includes appliance docking bays 62b and 62c into which a selected appliance module 30a, 30b, or 30c may be operatively coupled to the platform unit 52.

While operatively coupled to the platform unit 52, the subscriber device 50, the video camera 11, and the selected appliance module(s) 30a, 30b, and/or 30c become an integral part of the subscriber interface of the communication space station 24. The module video camera 11 provides a video image for use by the communication space station 24 when participating in a video conference call. A liquid crystal graphic display on the subscriber device 50 and/or the appliance modules 30a, 30b, and/or 30c may function to display multi-media communication management information under control of the platform unit 52 and the control unit 12. Programmable subscriber controls 92 positioned adjacent to the subscriber device 50 may be configured to activate platform unit 52 and control unit 12 functions in accordance with the contents of the graphic display 90 adjacent to the controls 92. And, subscriber controls on each of the selected appliance modules 30a, 30b, and/or 30c may activate platform unit 52 and control unit 12 functions to control the appliance module 30a, 30b, and/or 30c.

The platform unit 52 may further include one or more of the following elements: a) a handset 98 similar to a traditional telephone handset to provide a subscriber voice interface, b) a speaker 100 and a microphone 102 to provide a hands-free subscriber voice interface, c) a modular battery pack 70 (which fits within a battery pack bay that is not shown) for operating power when the communication space station 24 is uncoupled from a line voltage, d) cell button 104 for single button selection of certain functions such as a wide area network communication function, and e) help button 106 for single button selection of a help function.

FIG. 4 shows a block diagram of the communication space station 24. The platform unit 52 includes an application controller 112 coupled to a local bus 116 that interconnects a controller 112 with a plurality of peripheral circuits that include a wireless module 94, a power management controller 120, a communication circuit 122, a network switch controller 124, a key switch controller 126, a touch panel controller 128, a plain old telephone service (POTS) converter 146, and a voice communication system 130.

The wireless module 94 operatively couples the platform unit 52 with the control unit 12 over the wireless LAN 22 (both of FIG. 1). The controller 112 includes appropriate drivers for operation of the wireless module 94.

The power management controller 120 selectively receives input power from the battery pack 70 or external line voltage 134. The power management controller 120 includes appropriate circuits for converting the input power voltage to appropriate operating power required by each component of the communication space station 24. Additionally, the power management controller 120 includes appropriate circuits for managing charging of the battery pack 70 when the platform unit 52 is coupled to the line voltage 134 and generating appropriate power for operating and/or charging the modular docking interface 58 and the modular subscriber device 50 when coupled to the platform unit 52.

The communication circuit 122 operatively couples the controller 112 to the modular docking interface 58 (and the modular subscriber device 50), the video camera 11, and each of the appliance modules 30a, 30b, and 30c such that the platform 52 can exchange data with each of such devices. In the exemplary embodiment the communication controller is a serial communication controller that enables the serial exchange of data with a compatible serial communication controller within the modular subscriber device 50 over a physical medium. An exemplary controller could be a USB hub or an Ethernet hub. Exemplary physical mediums could include hardwired contacts, an infrared transmission, and RF transmission, however other controllers and physical mediums are envisioned and the selection of a physical medium is not critical to this invention.

The key switch (e.g. button) controller 126 is coupled to: 1) a connector 136a which in turn is coupled to a mating connector on the modular subscriber interface unit 60a (FIG. 3) for interconnecting the buttons 68 to the key switch controller 126; 2) a connector 136b which in turn is coupled to a mating connector 142 on the function specific module 54 for interconnecting the buttons 76 and 86 to the key switch controller 126; 3) the bus port 134 which in turn is coupled to a mating port 148 on the function specific module 56 for interconnecting the buttons 78 and 80 to the key switch controller 126; 4) the cell button 104; 5) and the help button 106. In the exemplary embodiment, the key switch controller 126 may drive row and column signals to the various buttons and, upon detecting a short between a row and a column (e.g. button activation) reports the button activation to the application controller 112 over the bus 116. Again, the application controller 112 includes appropriate drivers for operating the key switch controller 126.

The touch panel controller 128 is coupled to a connector 144 which in turn is coupled to a mating connector on the modular subscriber interface unit 60b (FIG. 3) for interconnecting the touch panel graphic display 72 to the touch panel controller 128. In the exemplary embodiment, the touch panel controller 128 may include a separate display control circuit compatible with the resolution and color depth of the touch panel graphic display 72 and a separate touch panel control circuit for detecting subscriber contact with the touch panel graphic display 72. The application controller 112 includes appropriate systems for driving the contents of the touch panel graphic display 72 through the touch panel controller 128.

The voice communication system 130 generates analog voice signals for driving the speaker 100 (or the speaker in the handset 98 of FIG. 3) and detects input from the microphone 102 (or the microphone in the handset 98) under the control the application controller 112.

In the exemplary embodiment, the controller 112 executes a packet audio/video communication client 113, a client application 115, and an appliance module support application 117. The packet audio/video communication client 113 provides for setting up UDP/IP channels for RTP packet voice and RTP packet video communications with the packet audio/video gateway 232 (FIG. 2) within the control unit 12. And, during the course of a audio or audio/video session, the packet audio/video communication client 113 compresses video images from the video camera into a sequence of RTP frames for sending to the gateway 232, compresses voice signals from the voice communication circuit 130 into sequences of RTP frames for sending to the gateway 232 and decompresses RTP frames of video images and audio signals received from the gateway 232 for driving the voice communication circuit 130 and for displaying a video image on a display. In the exemplary embodiment, the packet audio/video communication client 113 may be one of the commercially available clients utilizing established protocols such as the International Telephone Union (ITU) H.323 protocols, The Internet Engineering Task Force (IETF) Session Initiation Protocols, or other protocols useful for signaling and establishing a real time streaming media session with the packet audio/video gateway 232.

The client application 115 operates as a client to the web server application 230 (FIG. 3) within the control unit 12. The client application 115 provides for the controller 112 to: a) generate an image on the touch panel graphic display 72 or on the graphic display 90 on the subscriber device 50 in accordance with display content and a style sheet received from the control unit 12; b) output an audio stream file received from the control unit 12 through the dialog system 130; c) execute processing steps in accordance with instructions received from the control unit 12; d) provide messages indicating subscriber actions (such as subscriber activation of the cell button 104, the help button 106, a touch panel virtual button, or any other button on the communication space station 24) to the web server application 230; e) activate the packet audio/video client 113 to set up a real time audio/video session with the packet audio/video gateway 232 (FIG. 2); f) identifying the modular configuration or subscriber interface configuration of the communication space station 24 and reporting the configuration to the control unit 12; and g) reporting the coupling of (and decoupling of) a subscriber device 50 and/or modules to the platform 52 of the communication space station 24 to the control unit 12.

The appliance module support application 117 operates as a client to the web server 34 (FIG. 3) within the control unit 12 to provide for the control unit 12 to support appliance modules 30a, 30b, and 30c. In the case of appliance module 30a, the appliance module support application 117 provides for: a) the subscriber to operate channel select buttons on the appliance module to select a streaming audio/video channel that includes data content (such as news, weather, finance) desired by the subscriber; and b) the controller 12 to send streaming audio/video media in accordance with the subscriber selection for display on display 488 and output by the speaker 490. In the case of appliance module 30b, the appliance module support application 117 provides for the control unit 12 to provide stock ticker data for output on the long narrow display screen 450. In the case of appliance module 30c, the appliance module support application 117 provides for reporting of subscriber activation of buttons on the appliance module to the control unit 12 and receipt of display screens for display to the operator on the display screen 476.

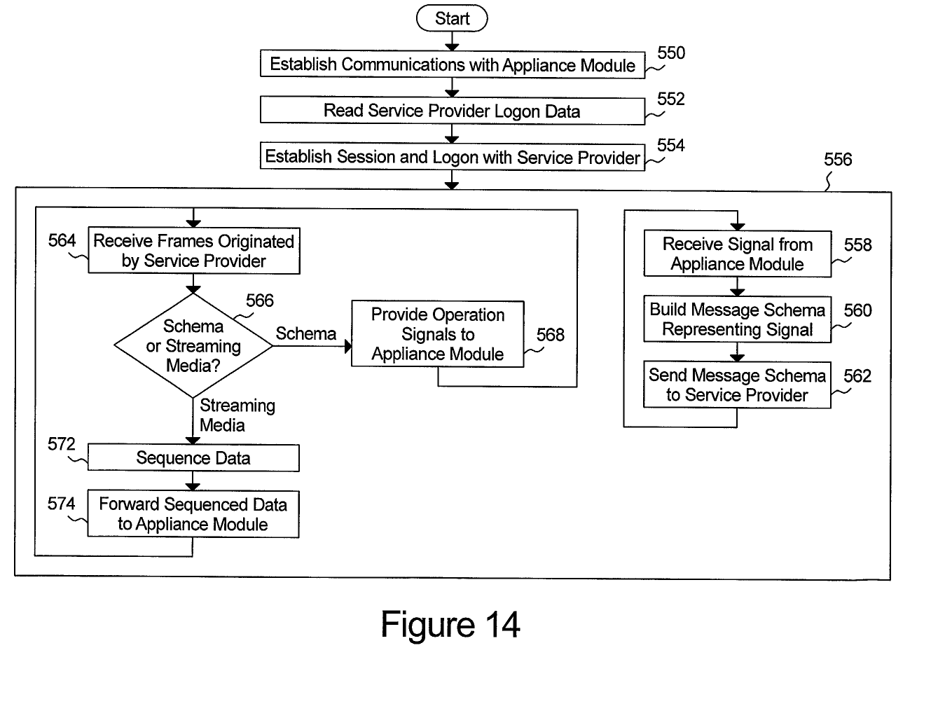

Turning briefly to the flow chart of FIG. 14, exemplary operation of the appliance module support application 117 is shown. Step 550 represents establishing communications with an appliance module utilizing the communication circuit 122 upon the appliance module being docked to the docking bay 62b or 62c.

Step 552 represents obtaining content application logon data. More specifically, this step may include reading a network address of either a local content application or a remote content application provider coupled to the network 18 from a memory as well as a logon id, password, and other data that may be useful initiating a session with the content application. Alternatively, this step may include obtaining all such data from the appliance module utilizing the communication circuit 122.

Step 552 represents using the content application logon data from step 552 to establish a session with the content application. Thereafter, the sub steps of step 556 represent operation of the appliance module support application 117 during the session. Sub-steps 558-562 represent the appliance module support application 117 receiving signals from the appliance module indicating subscriber operation of buttons on the appliance module (or other subscriber controls) at substep 558. Step 560 represents extracting the data from the received signals to identify the indication of subscriber operation of the button and building a frame that includes message schema comprising a data element representing the subscriber activation and a tag identifying the data element. Step 562 represents sending the frame to the content application utilizing a communication protocol compatible with network 22 and the content application.

Sub-steps 564-568 represent interfacing data received from the content application to the appliance module. Sub-step 564 represents receiving frames of data from the content application. The frames of data may be RTP frames representing streaming audiolvideo data or may be a message schema that includes tagged data elements. If at step 556, the frames are determined to be RTP frames, step 572 represents chronologically sequencing the compressed streaming audio or audio/video data from the received frames. Step 574 represents providing a digital signal representing the sequenced streaming media data to the appliance module utilizing the communication circuit 122. Alternatively, if at step 556 the frames are determined to be a message schema, step 568 represents extracting a data element value from the message schema along with identifying the data element providing operating instructions (that may include both the data element value and the identify of the data element) to the appliance module. An example would include operating instruction to refresh a graphic image on an appliance module display screen

Subscriber Data Assistant

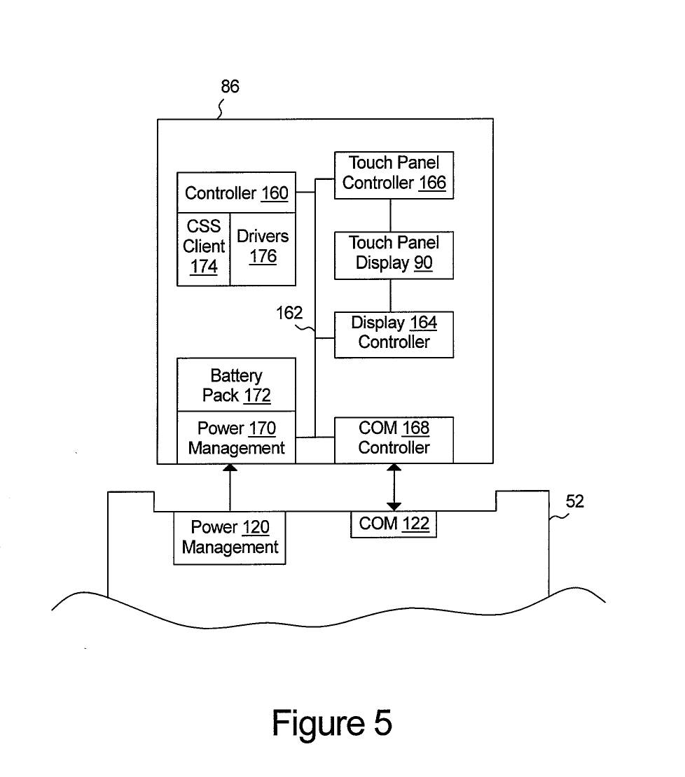

Turning to FIG. 5, exemplary structure of a subscriber data assistant 86 is shown. The subscriber data assistant 86 includes a controller 160 interconnected to a plurality of peripheral controllers by an internal bus 162. Because of the small size and the portability of the subscriber data assistant 86, the touch panel 90 provides the primary subscriber interface. The touch panel 90 is controlled by a display controller 164 and a touch panel controller 166. The display controller 164 drives the liquid crystal display of touch panel 90 using signals compatible with the resolution and color depth of the display 90. The touch panel controller 166 detects user activation of the touch panel 90. The controller 160 operates appropriate drivers 176 for controlling operation of the touch panel controller 166 and the display controller 164.

A communication controller 168 is also coupled to the bus 162 and operates under control of the application controller 160. In the exemplary embodiment, the communication controller 168 is a serial communication controller that is compatible with the communication circuit 122 of the platform unit 52 (both of FIG. 4) such that data communication may occur between the platform unit 52 and the subscriber data assistant 86 when the subscriber data assistant 86 is operatively coupled to the platform unit 52.

A power management circuit 170 selectively receives input power from a battery pack 172 or from the power management circuit 120 in the platform unit 52. The power management circuit 170 includes appropriate circuits for converting the input power voltage to appropriate operating power required by each component of the subscriber data assistant 86. Additionally, the power management circuit 170 includes appropriate circuits for managing charging of the battery pack 172 when the subscriber data assistant is coupled to the platform unit 52.

The controller 160 also operates a communication space station client application 174 for displaying multi-media communication management information under control the platform unit 52 when coupled to the platform unit 52. In the exemplary embodiment the communication space station client application 174 receives messages from the platform unit 52 in the form of tagged messages. After receipt of the tagged messages, the communication space station client application 174 builds a display document to display the communication management information represented by tagged content messages in accordance with a style sheet that is compatible with the size, resolution, and color depth of the touch panel display 90. The display document is then displayed on the touch panel display 90.

It should be appreciated that in additional to operating the drivers 176 and the communication space station client application 174, the controller 160 may optionally operate any of the software applications that are commercially available for portable data assistants (PDAs) which may include address book management software, calendar management software, and games. While operation of such PDA applications may be useful to the subscriber, it is not critical to the operation of the present invention.

Subscriber Wide Area Network Communication Device

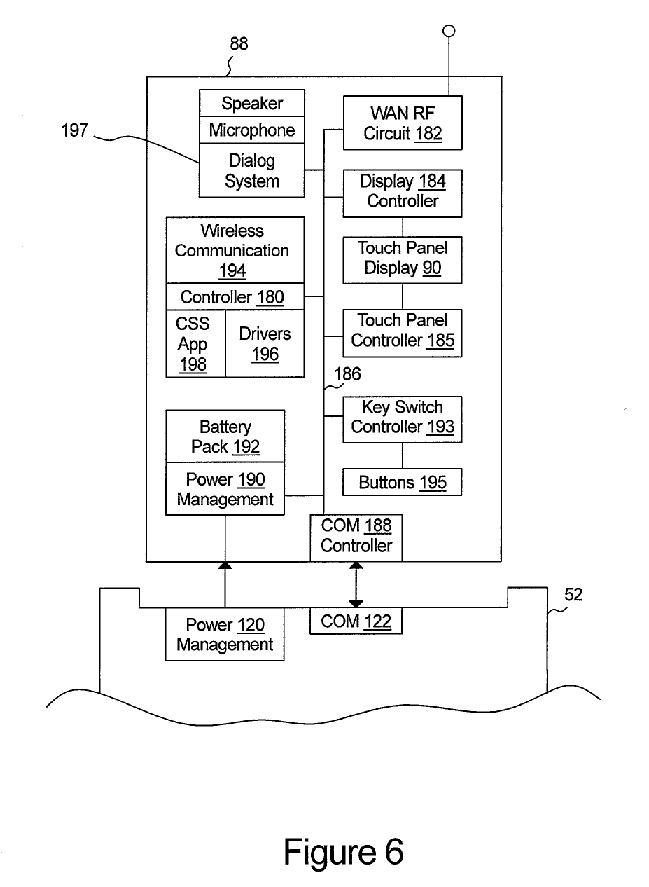

Turning to FIG. 6, exemplary structure of a subscriber wide area network communication device 88 is shown. The wide area network communication device 88 includes a controller 180 operating a Communication Space Station application 174′, the subscriber contact directory application 178, a wireless communication application 194, and applicable drivers 196 for a plurality of peripheral controllers. The controller 180 is interconnected to the plurality of peripheral controllers by an internal bus 186. The peripheral controllers include a wide area network RF circuit 182, a voice system 197, a display controller 184, a touch panel controller 185, a key switch controller 193, a communication controller 188, and a power management system 190.

The wide area network RF circuit 182 may be a circuit for transmitting and receiving signals from a wide area network service provider's medium under control of the wireless communication application 194. Exemplary wide area network service provider mediums include an analog or digital cellular or PCS telephone RF system.

The key switch controller 193 is coupled to the control buttons 195. The key switch controller 193 drives row and column signals to the control buttons 195 and, upon detecting a short between a row and a column indicating button activation, reports the activation to the controller 180. The control buttons may be used by a subscriber for operating the wide area network communication device 88 when uncoupled form the platform unit 52.

The voice system 197 includes a speaker and a microphone. Under control of the wireless communication application 194, the voice system 197 may provide a subscriber voice interface for an audio session with a remote device over the wide area network service provider's medium.

The display controller 184 drives the display 90 using signals compatible with the resolution and color depth of the display 90. The display 90 may optionally be a touch panel display 90 and the touch panel controller 185 detects user activation of the touch panel 90.

The communication controller 188 may be a serial communication controller compatible with the communication circuit 122 in the platform unit 52 such that data communication may occur between the platform unit 52 and the wide area network communication device 88 when the wide area network communication device is operatively coupled to the platform unit 52.

The power management controller 190 operating with a battery pack 192, both of which may operate in a similar manner to the power management controller 170, and the battery pack 172 discussed with reference to FIG. 5.

Similar to the subscriber data assistant 86 (FIG. 5), when the wide area network communication device 88 is coupled to the platform unit 52, the Communication Space Station application 174′ provides for displaying multi-media communication management information under control the platform unit 52 and provides for multi-media communication directly between the platform unit and the wide area network service provider medium.

In addition the Communication Space Station application 174′ may receive messages from the platform unit 52 which may be multi-media communication messages for communication over the wide area network service provider medium. Each message includes a tag that identifies the contents of the message. After receipt of a tagged message, the Communication Space Station application 174′ may identify whether the message is for communication with the wide area network service provider medium or whether it is multi-media communication management information for display.

When the message is for communication with the wide area network service provider medium, the Communication Space Station application 174′ will reformat the message to a format compatible with wide area network service provider medium transmission standards and transmit the message using the wide area network RF circuit 182.

The wide area network communication device 88 may also receive signals from the wide area network service provider medium via the wide area network RF circuit 182. When received, the Communication Space Station application 174′ reformats the messages into a plurality of tagged messages for communication to the platform unit 52 and sends the tagged messages to the platform unit 52 via the communication controller 188.

Wireless Voice Handsets

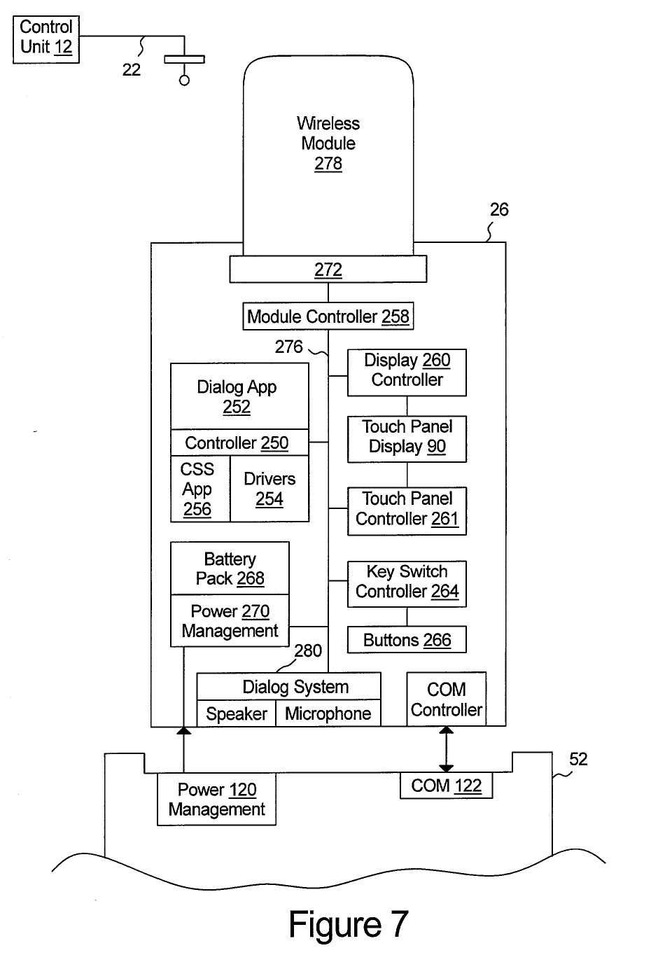

FIG. 7 shows a block diagram of an exemplary wireless dialog handset 26. The wireless voice handset 26 includes a network circuit 278 and a controller 250 that operates a Communication Space Station application 174″, the subscriber contact directory application 178, a LAN communication application 252, and applicable drivers 254 for each of a plurality of peripheral controllers. The controller 250 is interconnected by a bus 276 to the plurality of peripheral controllers which include a module controller 258, a display driver 260, a touch panel driver 261, a key switch controller 264, and a power management circuit 270.

The module controller 258 operatively couples the network circuit 278 to the controller 250 such that the wireless voice handset 26 may communicate with the control unit 12 over the wireless LAN 22 (both of FIG. 1). In the exemplary embodiment, the module controller 258 may be a PCMCIA controller circuit and the network circuit 278 is configured as a PCMCIA card that coupled to the module controller 258 through a PCMCIA connector 272. The LAN communication application 252 operates the network circuit 278 for communicating with the control unit 12 using appropriate wireless signaling protocols.

The key switch controller 264 is coupled to the control buttons 266. The key switch controller 264 drives row and column signals to the control buttons 266 and, upon detecting a short between a row and a column indicating button activation, reports the activation to the controller 250. The control buttons may be used by a subscriber for operating the wireless voice handset 26 when uncoupled form the platform unit 52.

The display controller 260 drives the display 90 (optionally a touch panel display 90) using signals compatible with the resolution and color depth of the display 90. The touch panel controller 261 detects user activation of the touch panel display 90. The power management controller 270 operates in conjunction with a battery pack 268, both of which may operate in a similar manner to the power management controller 170, and the battery pack 172 discussed with reference to FIG. 5.

When the wireless voice handset 26 is coupled to the platform unit 52, the Communication Space Station application 174″ provides for displaying multi-media communication management information under control the platform unit 52. Additionally, the Communication Space Station application 174″ may receive multimedia communication management information content messages and control messages directly from the control unit 12 via the wireless network 22. After receipt of the tagged messages from either the platform unit 52 or the control unit 12, the Communication Space Station application 174″ builds a document to display the communication management information represented by the tagged content messages in accordance with display layout control messages that are compatible with the size, resolution, and color depth of the touch panel display 90. The display document is then displayed on the touch panel display 90.

Stock Ticker Appliance Module

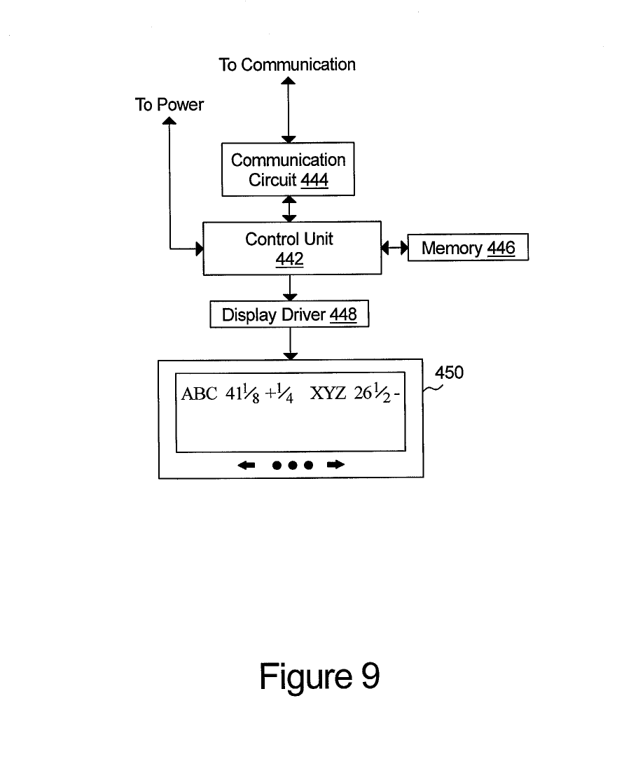

Referring to FIG. 9, a block diagram of an exemplary stock ticker appliance module 30b is shown. The appliance module includes a control unit 442, a communication circuit 444, a memory (which may be embedded with the control unit) 446, a display driver 448, and a long narrow display useful the display of streaming stock ticker data.

The communication circuit 444, operating under control of the control unit 442, utilizes communication protocols that are compatible with the communication circuit 122 (FIG. 4) such that the communication circuit may receive stock ticker data while secured to the docking bay 62c (FIG. 4).

The display driver 448, operating under control of the control unit 442, reads a virtual representation of the display in the memory 446 and provides row and column signals for driving the display 450 to show a streaming stock ticker in accordance with a virtual representation of display content in the memory 446.

The control unit 442 includes circuits for operating the communication circuit 444 and the display driver 448 and for receiving the stock ticker data from the communication circuit 444 and writing a virtual representation of screen content of a streaming ticker to the memory 446.

In operation, the control unit 442 initiates communication with the communication space station 24 at start up and may identify either a local content application or a remote content application coupled to the service provider network 18 that provides stock ticker data.

Thereafter, the control unit 442 coordinates the receipt of stock ticker data from the communication space station 24 utilizing the communication circuit 444 and the display of streaming stock ticker data utilizing the display driver circuit 448.

Time Billing Appliance Module

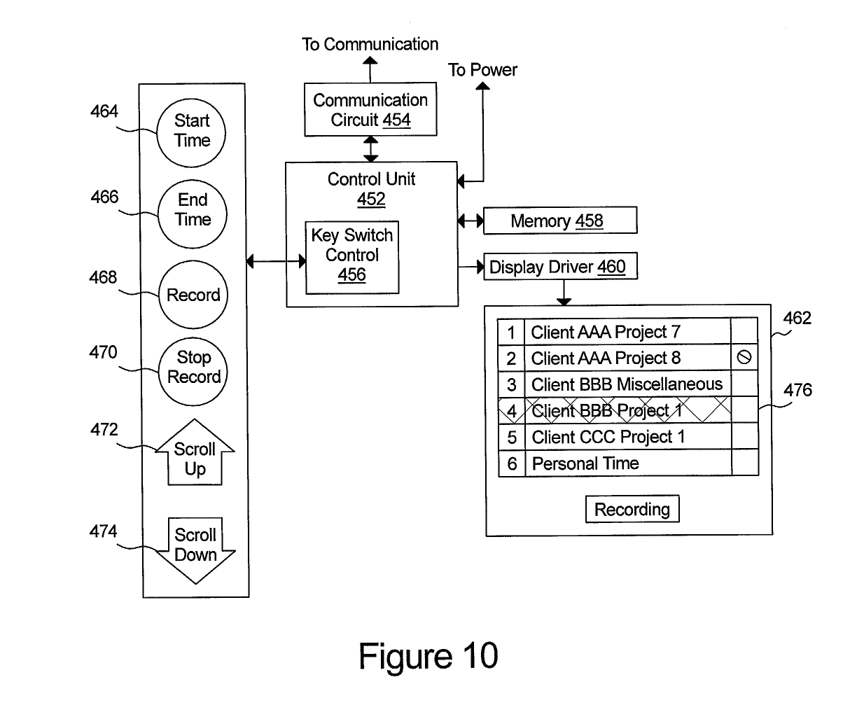

Referring to FIG. 10, a block diagram of an exemplary time and billing appliance module 30c is shown. The appliance module includes a control unit 452, a communication circuit 454, a memory (which may be embedded with the control unit) 458, a display driver 460, a display 462, and a plurality of subscriber activated buttons 464-474.

The communication circuit 454, operating under control of the control unit 452, utilizes communication protocols that are compatible with the communication circuit 122 (FIG. 4) such that the communication circuit may provide indications of subscriber activation of buttons 464-474 to the communication space station 24 and receive data for display on the display screen 462 from the communication space station 24 while secured to the docking bay 62b (FIG. 4).

The display driver 460, operating under control of the control unit 452, reads a virtual representation of the display in the memory 458 and provides row and column signals for driving the display 462 to show a graphic display of information to the subscriber in accordance with the virtual representation of display content in the memory 458.

The control unit 452 includes a keyswitch control circuit 456 coupled to each of the buttons 464-474 for detecting subscriber activation of a button 464-474, circuits for operating the communication circuit 454, and circuits for operating the display driver 460.

In operation, the control unit 452 initiates communication with the communication space station 24 at start up and may identify either a local content application or a remote content application coupled to the service provider network 18 that provides time and billing services.

Thereafter, the control unit 452 coordinates the receipt of time and billing data and the sending of indications of subscriber activation of the buttons from and to the communication space station 24 utilizing the communication circuit 454 and the display of the billing data utilizing the display driver circuit 462.

The buttons 464-474 are each labels with the function that, when activated, will be performed by the control unit 452 or the local or remote content application. For example, activation of the scroll up button 472 or scroll down button 474 initiates the control unit 452 to scroll (up or down respectively) a highlight bar 476 on a list of projects on the display 462. If the control unit 452 stores an entire list of projects locally, the scrolling may be performed by the control unit 452. Alternatively, if the display 462 only displays an image provided by the content application, the scrolling would be performed by the content application and a new display image would be provided to the control unit for display. Activation of the start time button 464 initiates the control unit 452 sending an indication of such activation to the content application so that the content application can begin accruing time to the project that was highlighted on the display 462 at the time of button 464 activation. Activation of the end time button 466 initiates the control unit 452 sending an indication of such activation to the content application so that the content application stops accruing time to a project. Activation of the record button 468 initiates the control unit 452 sending an indication of such activation to the local content application so that the local content application can activate the recording module 39 in the packet voice/video gateway 232 to begin recording an audio (or audio/video) session. Activation of the stop record button initiates the control unit 452 sending an indication of such activation to the local content application to deactivate the recording module 39 and stop recording an audio or audio/video session.

Selectable Media Channel Appliance Module

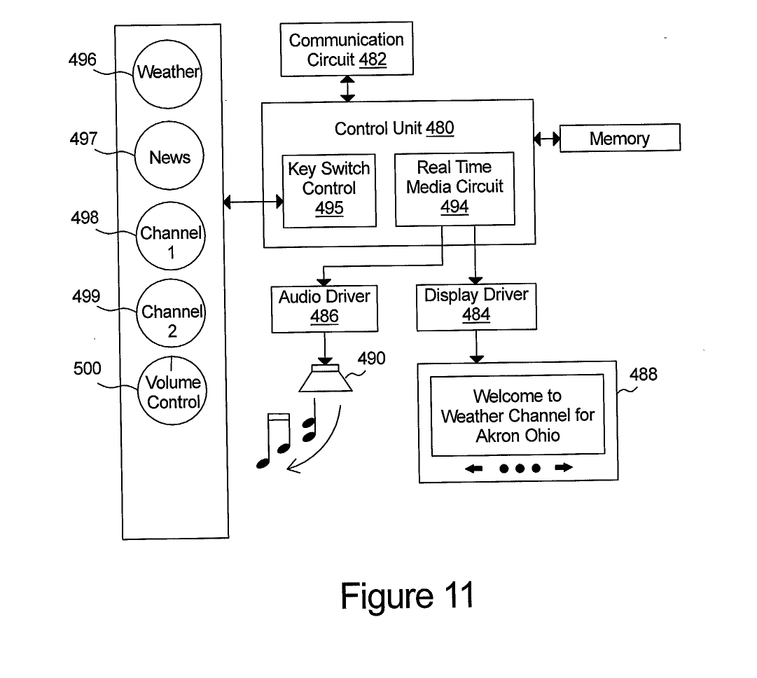

Referring to FIG. 11, a block diagram of an exemplary selectable media channel appliance module 30a is shown. The appliance module includes a control unit 480, a communication circuit 482, a memory (which may be embedded with the control unit) 492, a display driver 484, a display 488, an audio driver 486, a speaker 490, a plurality of subscriber activated buttons 496-499, and a subscriber activated volume control 500.

The communication circuit 482, operating under control of the control unit 480, utilizes communication protocols that are compatible with the communication circuit 122 (FIG. 4) such that the communication circuit may provide indications of subscriber activation of buttons 496-499 and activation of volume control 500 to the communication space station 24 and receive streaming audio/video programming for display on the display screen 488 and for output by the speaker 490 from the communication space station 24 while secured to the docking bay 62b (FIG. 4).

The display driver 484 obtains a digital video signal from a real time media decompression circuit 494 and provides row and column signals for driving the display 488 to show a full motion video of the programming.

The audio driver 486 obtains digital audio data from the real time media decompression circuit 494 and provides an analog signal for driving the speaker 490 to provide audio coinciding with the video programming.

The control unit 480 includes a circuit for operating the communication circuit 454, a circuit for operating the display driver 460, and a keyswitch control circuit 495 coupled to each of the buttons 496-499 and to the volume control 500 for detecting subscriber activation of such buttons and volume control.

In operation, the control unit 480 initiates communication with the communication space station 24 at start up and may identify either a local content application or a remote content application coupled to the service provider network 18 that provides audio/video programming such as news, weather, or other information programs.

Thereafter, the control unit 480 coordinates the receipt of real time streaming audio/video programming and the sending of indications of subscriber activation of the buttons 496-499 and the volume control 500 from and to the communication space station 24 utilizing the communication circuit 482 and coordinates the display of and the audio output of the real time streaming media audio/video programming utilizing the display driver circuit 484 and the audio driver circuit 486.

The buttons 496-499 are each labeled with program content that, when activated by the subscriber, will initiate the control unit 480 sending an indication of such button activation to the content application to initiate the feed of real time audio/video data that corresponds with the selected program content. For example, activation of the weather button 496 will initiate the control unit 480 sending an indication of such button activation to the content application and the content application will begin sending streaming audio/video data that provides weather information to the subscriber. Similarly button 497 provides news information to the subscriber.

Communication Space Station Management Application

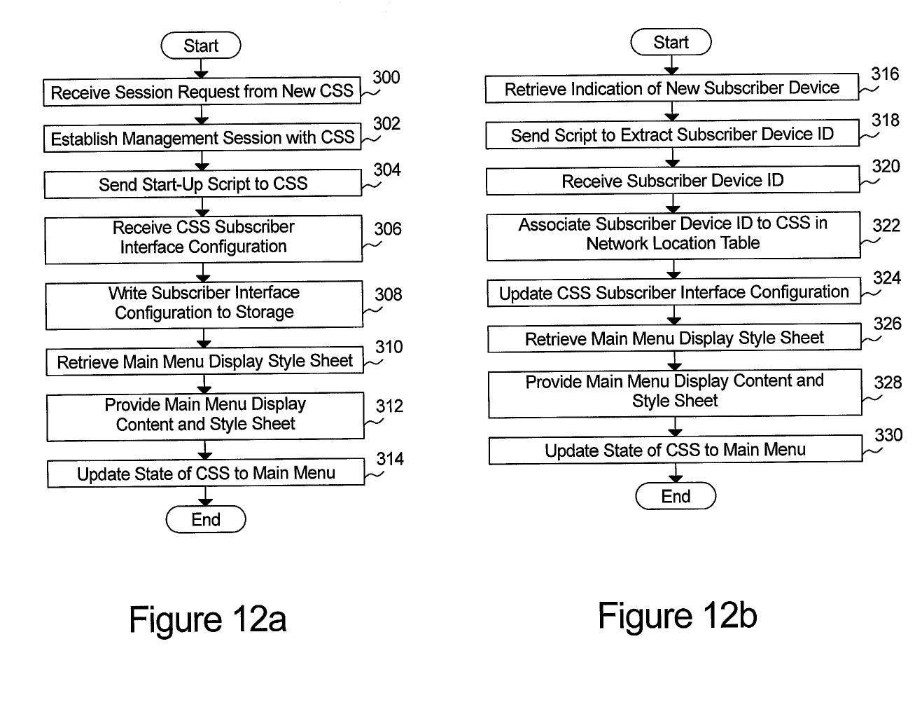

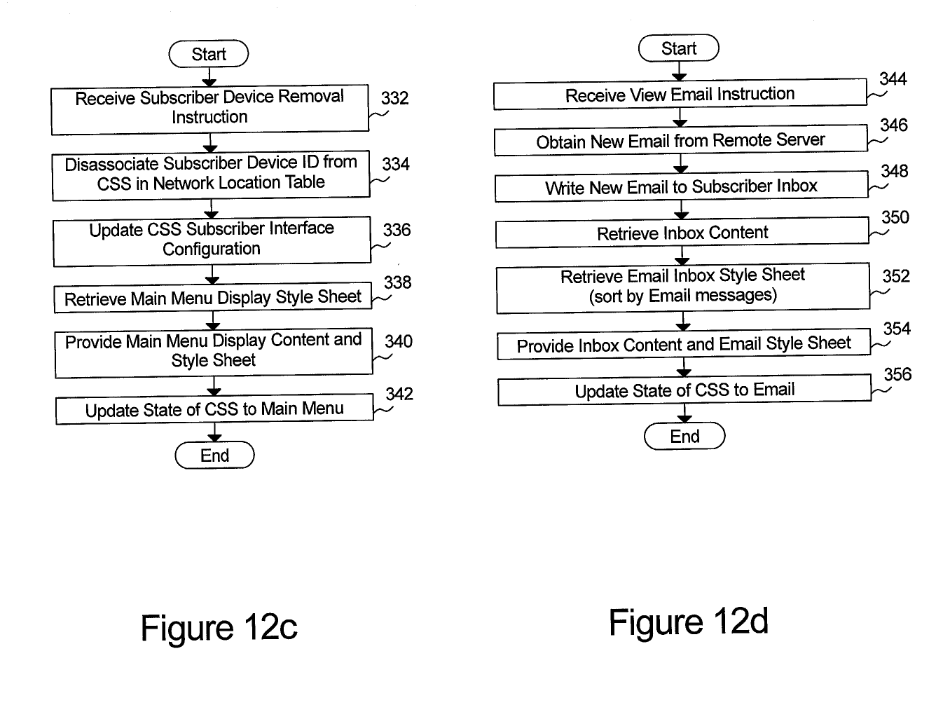

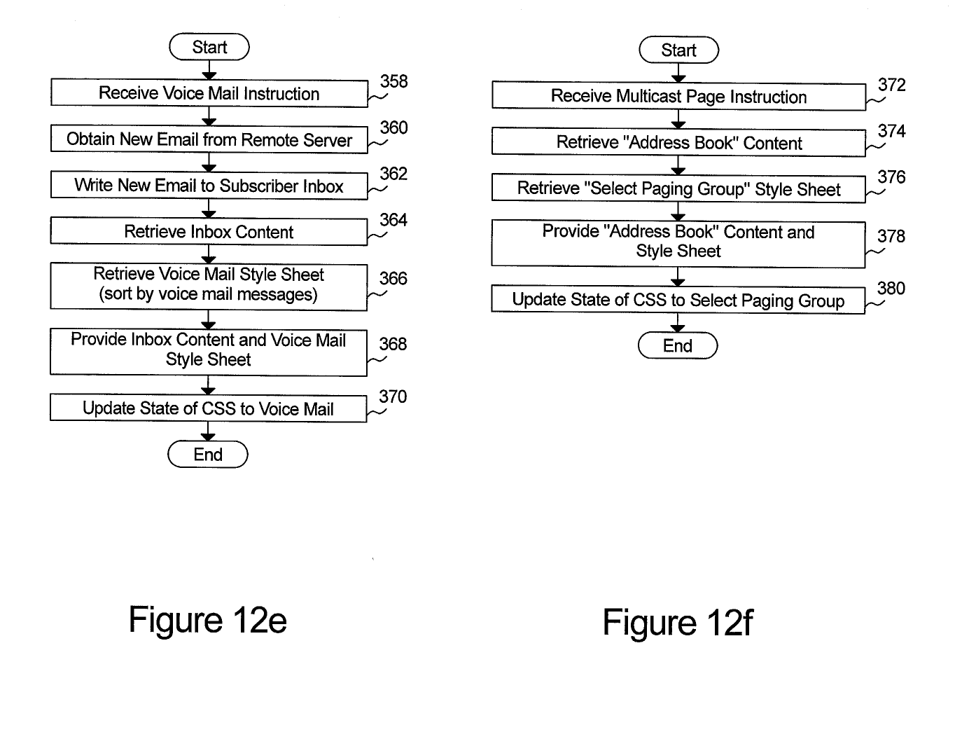

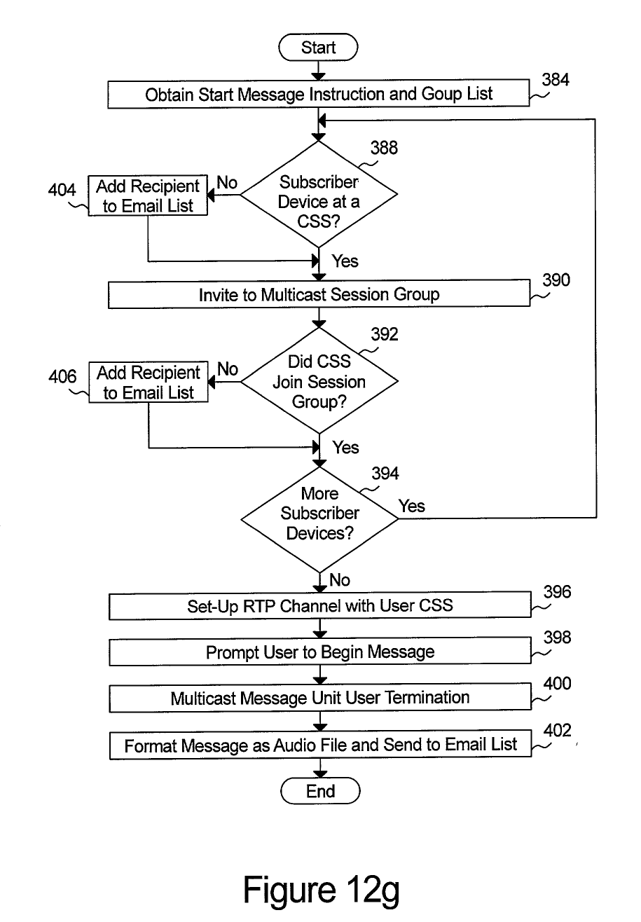

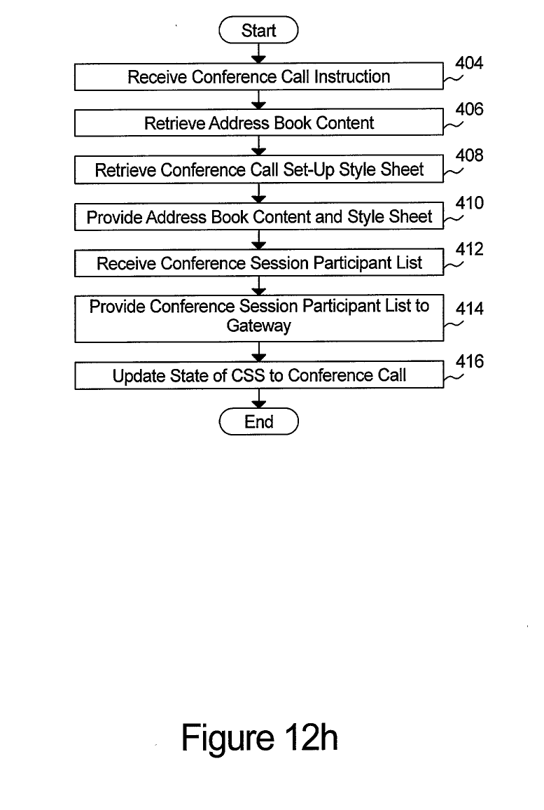

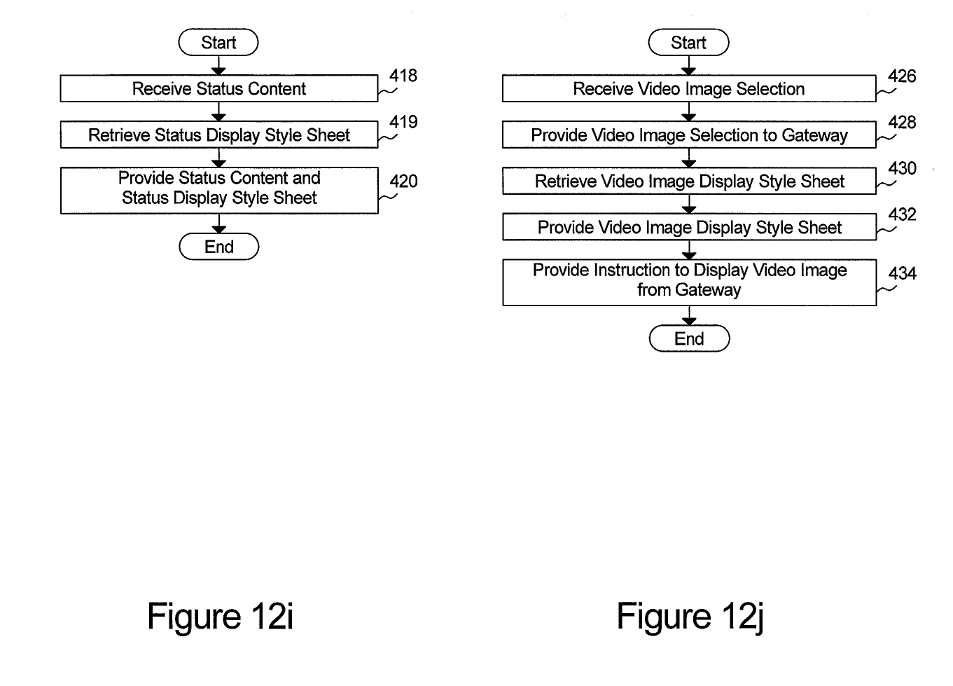

The flowcharts of FIGS. 12a through 12j represent exemplary processing steps performed by the communication space station management application 230 to provide control of communication services to a communication space station 24.

Referring to the flowchart of FIG. 12a in conjunction with FIG. 2, steps performed by the communication space station management application 230 upon receiving an open session request on a predetermined port from a communication space station 24 that has just been operatively coupled to the network 22, obtained a network address from the network address server 220, and is ready to operate as a client to the communication space station management application 230. Step 300 represents receipt of the open session request and step 302 represents establishing a TCP/IP session with the communication space station 24.

Step 304 represents sending a start up script to the communication space station 24. The start up script includes instructions that, when executed by the client application 115, provide for the communication space station 24 to detect its subscriber interface configuration (e.g. whether the communication space station 24 includes a display screen and what capabilities such as video capabilities and graphic resolution capabilities the display screen may have) and to report its subscriber interface configuration back to the communication space station management application 230.

Step 306 represents receipt of the subscriber interface configuration of the communication space station 24 from the communication space station 24 and step 308 represents writing an indication of the subscriber interface configuration of the communication space station 24 to a subscriber interface table 239 in the storage 235.

Step 310 represents retrieving a main menu display style sheet from a selection of style sheets 241 stored in the storage 235. The retrieved main menu display style sheet will be a style sheet that corresponds to the subscriber interface configuration of the communication space station 24.

Step 312 represents providing main menu display content and the style sheet to the communication space station 24 and step 314 represents updating a communication space station state table 243 in the storage 235 to indicate that the communication space station 24 is in a main menu state.

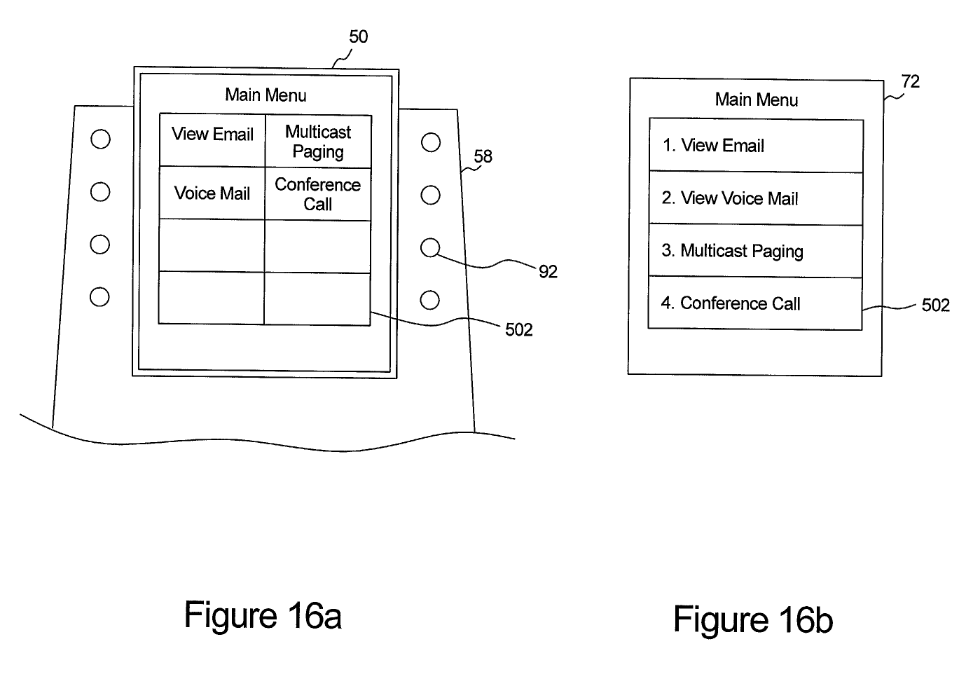

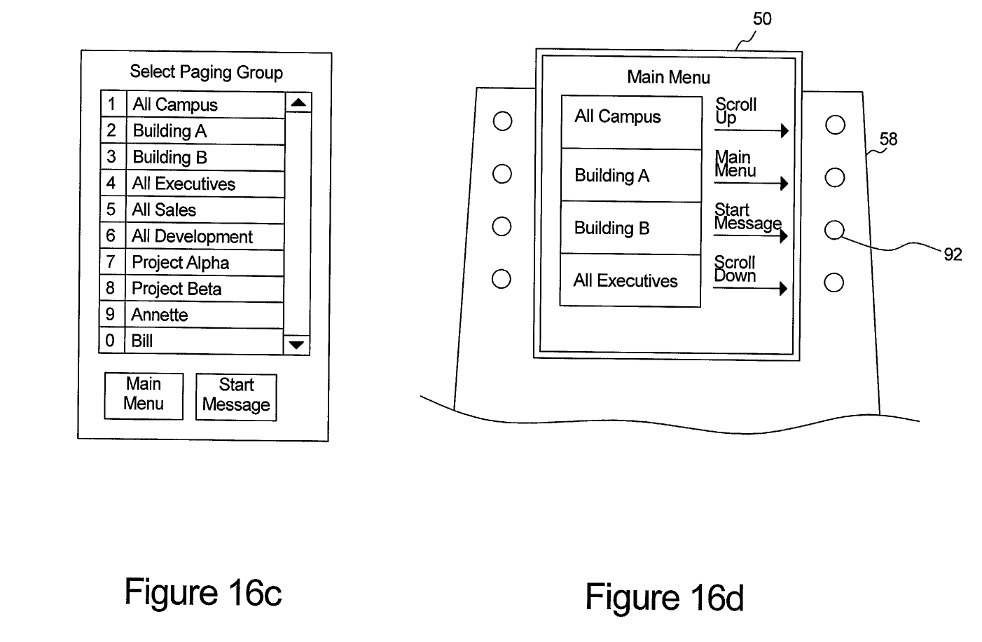

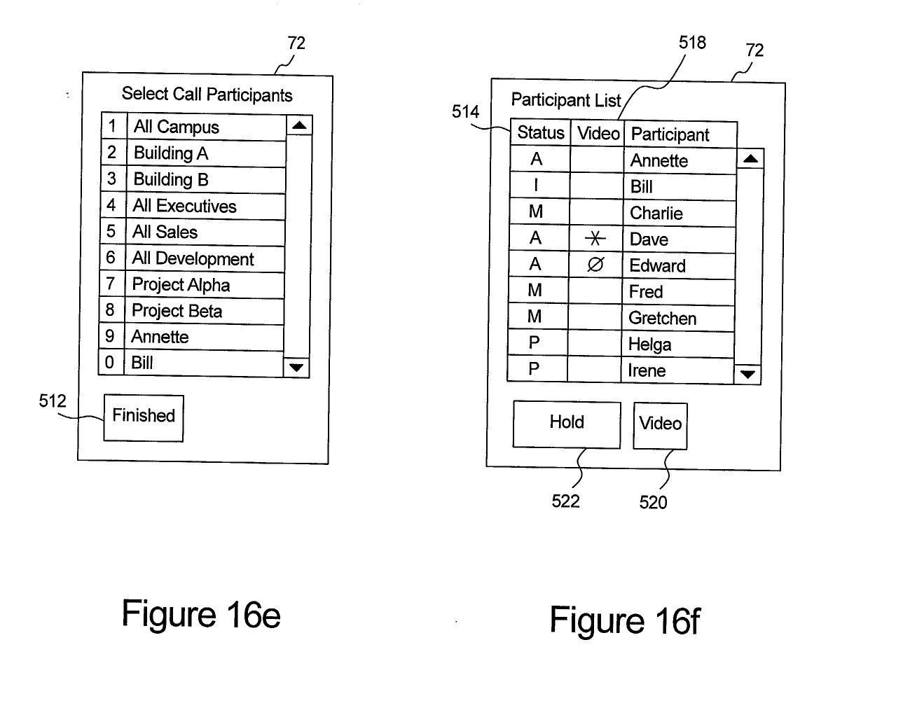

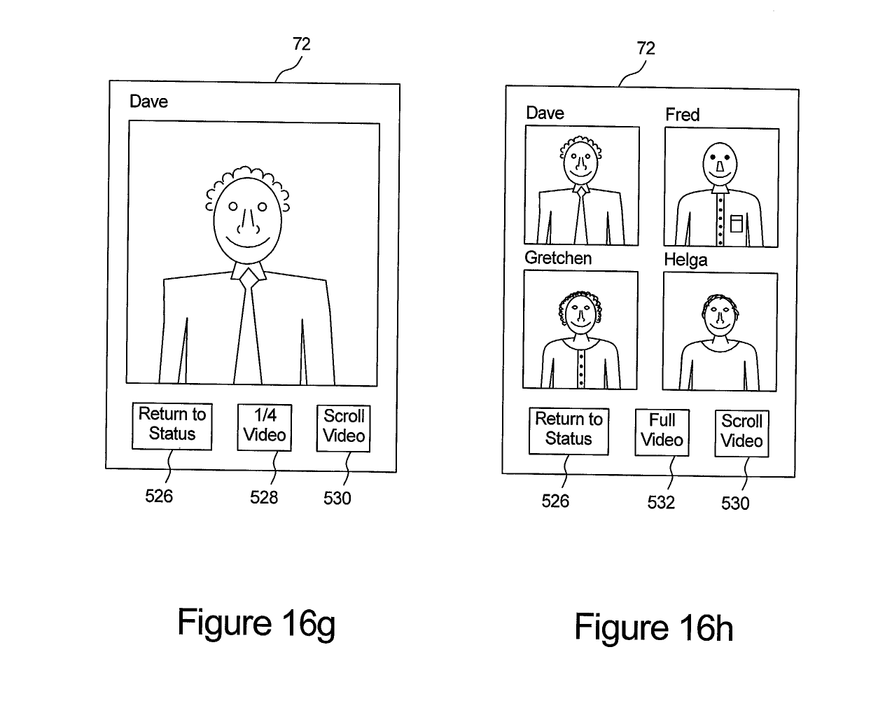

It should be appreciated that the main menu content provided to the communication space station 24 is independent of the subscriber interface, however, the style sheet provided to the communication space station 24 is dependent on the subscriber interface. For example, turning to FIG. 16a which represents display of a main menu on a subscriber device 50 in the modular docking interface 58 the content of the main menu display includes a title of main menu and choices of view email, voice mail, and multi cast paging. The style sheet corresponding to a subscriber interface that includes a subscriber device 50 provides for the content to be graphically displayed with the title at the top and each menu choice to be displayed adjacent a button 92 on the modular docking interface 58. Alternatively, turning to FIG. 16b which represents display of a main menu on a display 72 that is coupled to a communication space station interface 64 (FIG. 3), the content of the main menu display again includes a title of main menu and the choices of view email, voice mail, and multi cast paging. However, the style sheet that corresponds to a subscriber interface that includes a display 72 that is coupled to a communication space station interface 64 provides for the content to be graphically displayed with the title at the top and each choice to be displayed in a vertical list with an adjacent numeral for selection using the keypad 68 (FIG. 3). The examples shown in FIGS. 16a and 16b are for illustrative purposes only. Other subscriber interface configurations that include non-graphic displays, bit mapped multi line text displays, or 7 element single or multi line text displays may utilized different style sheets for displaying all or a portion of the main menu content.

The flowchart of FIG. 12b represents steps performed by the communication space station management application 230 upon receiving an indication that a subscriber device 50 has been coupled to a communication space station 24. Step 316 represents receipt of such indication.

Step 318 represents sending a device ID extraction script to the communication space station 24. The device ID extraction script includes instructions that, when executed by the client application 115, provide for the communication space station 24 to interrogate the subscriber device 50 to determine its device identification (e.g. an identification of which subscriber to which the device has been assigned) and to report the device identification back to the communication space station management application 230.

Step 320 represent receipt of the device identification back from the communication space station 24 and step 322 represents associating the device ID with the communication space station 24 in the network location table 245 in the storage 235. As discussed previously, the packet audio/video gateway 232 utilizes the network location table 245 for routing incoming telephone calls to the particular communication space station 24 at which a subscriber's subscriber device 50 is then currently coupled. It should be appreciated that this step 322 provides for the network location table 245 to properly indicate association between a communication space station 24 and the subscriber device 50 that is served thereby.

Because the style sheet selected for display of content on the communication space station 24 is dependent on the subscriber interface configuration of the communication space station 24 as determined by the subscriber interface table 239, the table should be updated when the subscriber interface configuration changes. Coupling a subscriber device 50 to a communication space station 24 changes the subscriber interface because the display of the subscriber device 50 becomes a display for the communication space station 24. As such, step 324 represents updating the subscriber interface configuration of the communication space station 24 in the subscriber interface table 239.

Step 326 represents retrieving a main menu display style sheet that is applicable to the new subscriber interface configuration from the selection of style sheets 241 in the storage 235 and step 328 represents providing main menu display contend and the style sheet to the communication space station 24. Step 330 represents updating the communication space station state table 243 to assure that it represents that the communication space station 24 is in the main menu state.

The flow chart of FIG. 12c represents steps performed by the communication space station management application 230 upon receiving an indication that a subscriber device 50 has been removed from a communication space station 24. Step 322 represents receipt of such an indication.

Because the packet audio/video gateway 232 utilizes the network location table 245 for routing incoming telephone calls to the particular communication space station 24 at which a subscriber's subscriber device 50 is then currently coupled. The network location table should be updated upon removal of a subscriber device form a communication space station 24. Step 334 represents disassociating the subscriber device 50 from the communication space station 24 in the network location table 245.

Because the display on the subscriber device 50 is no longer part of the subscriber interface of the communication space station 24 after the subscriber device 50 is removed, step 336 represents updating the subscriber interface configuration table 239.

Step 338 represents retrieving a main menu display style sheet that is applicable to the subscriber interface configuration without the subscriber device 50 from the selection of style sheets 241 in the storage 235 and step 340 represents providing main menu display content and the style sheet to the communication space station 24. Step 342 represents updating the communication space station state table 243 to assure that it represents that the communication space station 24 is in the main menu state.

The flowchart of FIG. 12d represents steps performed by the communication space station management application 230 upon receiving a subscriber indication of a command to view subscriber email messages. The means by which the communication space station 24 may detect such a subscriber indication is dependent on the subscriber interface configuration of the communication space station 24. For example, if the subscriber interface includes the email button 78 (FIG. 3), detection of button 78 activation would be a subscriber indication of a command to view subscriber email messages. Similarly, subscriber activation of the email menu choice on the main menu either by touch panel activation or by activation of a button associated with the menu choice (either or both of which may be applicable dependent on the subscriber interface configuration) would be a subscriber indication of a command to view subscriber email messages. Step 344 represents the communication space station management application 230 receiving the subscriber indication of a command view subscriber email messages.

Step 346 represents instructing the email module 228 to logon onto an email server (which may be a remote email server coupled to the network 18) and to receive new email messages associated with the subscriber's account. Step 348 represents writing the new email messages to the subscriber inbox in the email files 247 in the storage 235. In an embodiment wherein the remote email server maintains subscriber inbox information, steps 346 and 348 may be viewed as synchronizing the email messages between the remote server and the email files 247. It should also be appreciated that the email module 228 may periodically retrieve new email messages and write to the subscriber inbox independently of whether the subscriber has activated an email control. As such, the inbox will already include new messages and steps 348 and 348 may not need to be performed in response to event 344.

Step 350 represents retrieving inbox content from the email files 247 and step 352 represents retrieving an inbox style sheet that is applicable to the subscriber interface from the style sheets 241 in the storage 235. Because the subscriber's voice mails will be sent to the subscriber's email account as audio files, it is possible that he email messages retrieved at step 346 will include both text based emails and emails from the voice mail server 226. Because the subscriber activated a command to view email messages the inbox style sheet provides for the display of the email messages received from senders other than the voice mail server 226 to be displayed first (or on the top of the display).

Step 354 represents providing the inbox content and style sheet to the communication space station 24 and step 356 represents updating the communication space station state table 243 to indicate that the communication space station 24 is in an email state.

The flowchart of FIG. 12e represents steps performed by the communication space station management application 230 receiving a subscriber indication of a command to obtain voice mail messages. Again, the means by which the communication space station 24 may detect such a subscriber indication is dependent on the subscriber interface configuration of the communication space station 24. For example, if the subscriber interface includes the voice mail button 76 (FIG. 3), detection of button 76 activation would be a subscriber indication of a command to obtain voice mail messages. Similarly, subscriber activation of the voice mail menu choice either by touch panel activation or by activation of a button associated with the menu choice would be a subscriber indication of a command to obtain voice mail messages. Step 358 represents the communication space station management application 230 receiving the subscriber indication of a command obtain voice mail messages.

Because voice mail messages will be sent as audio files form the voice mail server 226 to the subscriber's email account, step 360 represents instructing the email module 228 to logon onto the email server and to receive new email messages associated with the subscribers account. Step 362 represents writing the new email messages to the subscriber inbox in the email files 247 in the storage 235.

Step 364 represents retrieving inbox content from the email files 247 and step 366 represents retrieving an voice mail style sheet that is applicable to the subscriber interface from the style sheets 241 in the storage 235. Because the email messages that include voice mail audio files from the voice mail server 226 may be intermixed with email messages from other senders, the voice mail style sheet provides for only the display of the voice mail messages received from the voice mail server 226.

Step 368 represents providing the inbox content and the voice mail style sheet to the communication space station 24 and step 370 represents updating the communication space station state table 243 to indicate that the communication space station 24 is in a voice mail state.

The flowchart of FIG. 12f represents steps performed by the communication space station management application 230 upon receiving a subscriber indication of a command to initiate a multicast paging message. The communication space station 24 may detect such a subscriber indication by various means, such as touch panel activation of button activation of a menu selection on the main menu, dependent on the subscriber interface configuration of the communication space station 24. Step 372 represents the communication space station management application 230 receiving the subscriber indication of a command to initiate a multicast paging message.

Step 374 represents retrieving the subscriber's address book content 249 from the email files 247. Turning briefly to FIG. 8b, the address book content 249 may comprise a plurality of records with each record including a group identification name and identification of each subscriber in such group, and, if the group identifies a single person, contact information for the person.

Step 376 represents retrieving a select paging group style sheet that corresponds to the subscriber interface of the communication space station 24 and step 378 represents providing both the address book content and the select paging group style sheet to the communication space station 24. Step 380 represents updating the communication space station state table 243 to indicated that the communication space station 24 is in the select paging group state.

FIG. 16c represents an exemplary display of the select paging group content utilizing a style sheet that may be applicable for use on a display 72 wherein the subscriber may use buttons or touch panel activation may be utilized to select one or more paging groups to include in the multicast page. It should be appreciated that some paging groups may include only a single name such that individuals may be selected to include in the multicast page. Because the list of groups included in the paging group content may be larger than can be displayed on the display 72, the style sheet may provide for only a portion of the content to be displayed along with touch activated scroll controls for display of the remainder of the content. The style sheet may further include touch activated controls to return to the main menu and to start the multicast message.

FIG. 16d represents an exemplary display of the select paging group content utilizing a style sheet that may be applicable for display of the content on a display of a subscriber device 50 coupled in the modular docking interface 58. Because subscriber selection is to be by activation of buttons 92, the style sheet provides for the content to be displayed with the groups on the left side for selection by buttons 92 on the left side of the modular docking interface 58 and for indicators to label the function of the buttons 92 on the right side of the modular docking interface 58 such as scroll up, scroll down, start message, and return to main menu.

The flowchart of FIG. 12g represents steps performed by the communication space station management application 230 upon receiving a subscriber indication of a command to start the multicast paging message. Step 384 represents receipt of such a subscriber indication along with identification of the subscriber selected multicast groups to include in a multicast recipient list.

Steps 388 through 394 represents steps that are performed by the communication space station management application 230 for each recipient. Such steps may be performed in sequence or in parallel. For purposes of illustration, the steps are shown performed in sequence. Step 388 represents identifying the subscriber device 50 that is associated with the recipient and determining if the subscriber device is then currently coupled to a communication space station 24. If yes, step 390 represents inviting such communication space station 24 to the multicast session group. However, if the subscriber device 50 associated with the recipient is not coupled to a communication space station 24 where the subscriber may receive the multicast, then at step 404 the recipient is added to an email list.

Following step 390, step 392 represents determining whether the communication space station 24 joined the multicast session group. If the communication space station 24 is operating a voice session, it would be inappropriate to interrupt the voice session with a multicast page for the subscriber. As such, it is envisioned that the communication space station 24 may, when in certain operational states, not join the multicast session group. In which case, the recipient is added to the email list at step 406. in an operational state wheutilizing the network location table 245 that associates each subscriber to a subscriber device 50.

After the recipient is either added to the email list at step 405 or the communication space station 24 joined the multicast session group at step 392, step 394 represents determining if steps 388 though 392 must be performed for additional recipients. If not, step 396 represents establishing a RTP channel with the communication space station 24 that initiated the multicast paging message and step 398 represent instructing the communication space station management to prompt the subscriber to begin the multicast paging message.

Step 400 represents multicasting the message to the session group utilizing the multicast module 231 and step 402 represents formatting the multicast message into an audio file and sending the audio file by email to each recipient that was added to the email list at either step 404 or 406.

The flowchart of FIG. 12h represents steps performed by the communication space station management 230 upon receiving a subscriber indication of a command to initiate an audio or an audio/video conference call from a communication space station 24. The communication space station may detect such a subscriber indication by various means, such as by subscriber activation of the conference call control 502 on the touch panel 72 of FIG. 16b or by activation of a button 92 corresponding to the conference call menu selection on the display screen 50 of FIG. 16a. Step 404 represents the communication space station management 230 receiving such an indication from a communication space station 24.

Step 406 represents retrieving the subscriber's address book content 249 from the email files 247 and step 408 represents retrieving a “select conference session participants” that corresponds to the subscriber interface of the communication space station 24 from the style sheets 241 in the storage 235. Step 410 represents providing both the address book content and the style sheet to the communication space station 24 for display.

Step 412 represents receiving subscriber selection of participants for the conference call. FIG. 16e represents an exemplary display of the address book for selection of conference call participants on the touch panel 72. The communication space station may detect subscriber activation of the touch panel 72 to “highlight” conference call participants and indicate that selection is complete by activating a finished control 512. Upon activation of the finish control, the communication space station will provide the subscriber selection of participants to the communication space station management 230.

Step 414 represents providing the conference session participant list to the packet audio/video gateway 232 and step 416 represents updating the state of the communication space station 24 to a conference call state.

After receiving the session participant list from the communication space station management 230, the packet audio/video gateway 232, or more specifically the call signaling module 227 (FIG. 2) will establish applicable audio and video communication channels with those communication space stations 24 that are serving subscriber devices associated with the participants in accordance with the steps discussed with respect to FIG. 11s. With the communication channels open, the packet voice gateway 232 will activate the conference mix module 237 to begin mixing the audio streams from each communication space station 24 participating in the call. The packet voice gateway will also report the status of each participant to the communication space station management 230. More specifically, the status will include an indication of whether each session participant is connected to the conference or is inactive (not connected to the conference. As will be discussed later, the status may also indicate whether the participant has stopped providing an active audio stream (e.g. put his or her phone on mute) and may indicate whether the conference mixing module has suspended sending a conference mix to the participant (e.g. the packet audio/video gateway 232 has placed a particular participant on hold for a time period to so that others can converse without such participant hearing the conversation).

The flowchart of FIG. 12i represents steps performed by the communication space station management application 230 upon receiving conference status content from the packet audio/video gateway 232. Step 418 represents receipt of the status content. Step 419 represents retrieving a “status” style sheet form the style sheets 241 in the storage 235 and step 410 represents providing the status content and the style sheet to at least the initiating communication space station 24 and optionally, to other communication space stations 24 participating in the conference call. It should be appreciated that the steps for the flowchart of FIG. 12i may be repeated several times during the duration of a conference call as the status of each participant changes.

FIG. 16f represents an exemplary display of the status of each participant on the touch panel 72. The display includes a vertical listing of each participant and an indication of the participants status in a column 514. An “A” indicates that the participant is active (e.g. sending a non-mute audio stream and receiving a conference mix audio stream). An “I” indicates that the participant is not on the conference call. A “M” indicates that the participant has muted his or here telephone and is not sending an audio stream. An “H” indicates that the participant has been placed on hold by the initiating communication space station and is not receiving a conference mix.

The display also includes a video indication column 516. This column indicates which participants are not sending a video image signal to the packet voice/video gateway 232 (e.g. the “Φ” symbol). Because the subscriber may select which of the participants to view during a video conference, the video column 516 will also indicate the subscribers selection of the video image to view if the subscriber activates the video control 520. In the exemplary display, the “*” symbol associated with Dave indicates that the subscriber would view the video image provided by Dave's communication space station 24 upon activating the video control 520. The subscriber may change such selection by utilizing the controls of the touch panel 72. Upon detecting activation of the video control, the communicating space station will report the indication to the communication space station management application 230.

The display also includes a hold control 522. The initiating subscriber may indicate his or her desire to place a participant(s) on hold status by highlighting the participant(s) and activating the hold control 522. Upon detecting activation of the hold control 522, the communication space station will report the indication to the communication space station management application 230. Upon receiving the indication, the communication space station management application 230 will provide the indication to the packet voice/video gateway 232 which will place the selected participant(s) on hold status and return updated status content to the communication space station management application 230.

The flow chart of FIG. 12j represents steps performed by the communication space station management 230 upon receiving a subscriber indication of a video image selection from a communication space station 24. Step 426 represents such receipt by the communication space station management 230. Step 428 represents providing the video image selection to the packet voice/video gateway 232. The packet voice/video gateway 232 will then begin relaying the selected video image to the subscriber station. Step 430 represents the communication space station management application 230 retrieving a style sheet for the display of the video image. Step 432 represents providing the style sheet to the communication space station 24 and step 434 represents providing instructions to display the video image received from the packet voice/video gateway 232 in conjunction with the style sheet.

FIG. 16g represents an exemplary display of a single video image on the touch panel 72. The display will include a control to return to the status page which, when activated, will cause the communication space station 24 to return to the display of FIG. 16f.

The display will also include a scroll video control 530 which, when activated will cause the communication space station 24 to report such activation to the communication space station management 230. The communication space station management 230 perform the steps discussed with respect to FIG. 12 with the selected image scrolled by one video image.

The display will also include a ¼ video control 528 which, when activated will cause the communication space station 24 to report such activation to the communication space station management application 230. The communication space station management application will perform the steps discussed with respect to FIG. 12 but the packet voice/video gateway 232 will provide a mixed video image comprising each of four video images arranged in the four corners of the display as represented by FIG. 16h.

From any of the displays associated with the conference call (e.g. FIG. 16e, FIG. 16f, FIG. 16g, and FIG. 16h, termination of the call will cause the communication space station 24 to return to the main menu as represented by FIGS. 16a or 16b.

Content Application

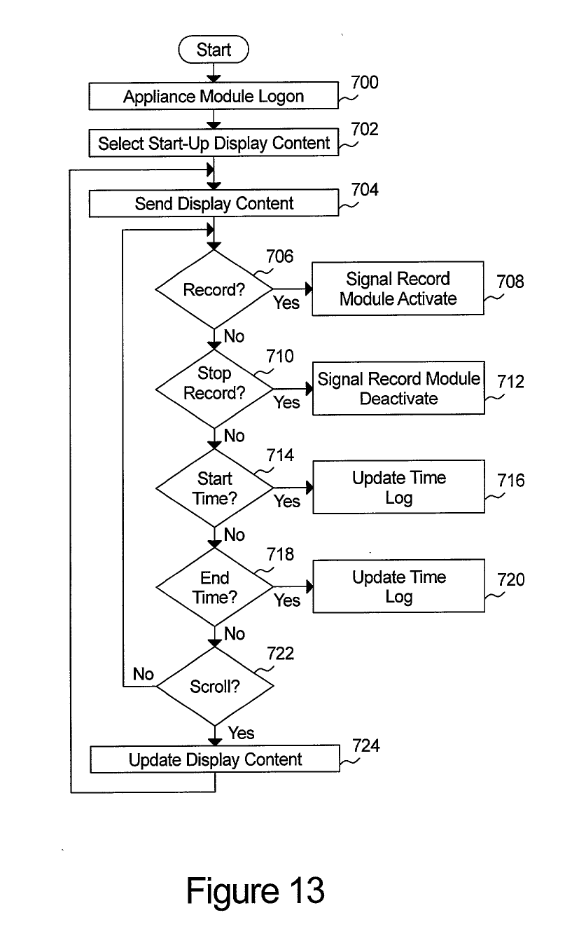

The flowchart of FIG. 13 represents and exemplary content application that supports the time and billing appliance module 30c. Step 700 represents establishing a session with the appliance module support application 117 of a communication space station 24 that serves a time and billing appliance module 30c in it docking station 62b. Step 702 represents selecting start up display content to provide to the communication space station 24 for display on the appliance module display. The start up display content may include a list of projects associated with the subscriber as shown in the display 476 of FIG. 10. Step 704 represents providing the display content to the appliance module support appliance module support application 117.

Thereafter, the content application waits for an indication of subscriber input that may include an indication of subscriber activation of the record button 468; the stop record button 470; the start time button 464; the end time button 466, or one of the scroll buttons 472-474 (all of FIG. 10).

If the subscriber input is activation of the record button at step 706, the content application signals the record module 39 at step 708 to initiate recording of the audio or audio/video session in which the communication space station 24 is participating. If the subscriber input is activation of the step record button at step 710, the content application signals the record module 39 at step 712 to terminate recording of the audio or audio/video session in which the communication space station 24 is participating.

If the subscriber input is activation of the start time button at step 714, the content application updates a time log to reflect a start time associated with the project highlighted by the subscriber at the time of button activation at step 716. If the subscriber input is activation of the end time button at step 718, the content application updates the time log to reflect an end time associated with the project highlighted by the subscriber at the time of button activation at step 720.

If the subscriber input is activation of a scroll button at step 722, the content application updates the display content to reflect the scroll at step 724 and sends new display content at step 704.

It should be appreciated that the systems and methods of the present invention provides for a modular and configurable communication space station that supports a subscribers multimedia communication needs. Although the invention has been shown and described with respect to certain preferred embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of the modular multi-media communication management system of the present invention. The present invention includes all such equivalents and modifications, and is limited only by the scope of the following claims.

What is claimed:

1. A multi-media communication base for serving a selected one of a plurality of data appliance modules, the communication base comprising:
a housing including:
a subscriber audio session interface, and
a docking station for coupling to the selected data appliance module;
a power circuit providing operating power to the communication base and coupled to the docking bay for providing operating power to the selected data appliance module;
a network communication circuit coupled to a network medium for exchanging frames of data over the network medium;
an appliance module communication circuit coupled to the docking bay for exchanging data with the selected appliance module;
an audio communication circuit comprising
means for directing the network communication circuit to establish an audio session with a remote audio device over the network medium;
means for translating:
audio signals originated by the subscriber audio interface to frames of data compatible the remote audio device's translation capabilities;
frames of data originated by the remote audio device to audio signals for driving the subscriber audio interface;
an appliance module support circuit comprising:
means for reading a network address of a service provider stored in at least one of the communication base and the appliance module;
means for directing the network communication circuit to establish a communication session with the service provider; and
means for translating a frame of data originated by the service provider to a signal compatible with transmission to the appliance module by the appliance module communication circuit.

2. The multi-media communication base of claim 1, wherein:
wherein the means for translating a frame of data originated by the service provider to a signal compatible with transmission to the appliance module by the appliance module communication circuit comprises:
means for extracting a value of a data element from the frame of data;
means for associating the value with a data element; and
means for generating a serial signal that identifies the data element and the value.

3. The multi-media communication base of claim 1, wherein:
wherein the means for translating a frame of data originated by the service provider to a signal compatible with transmission to the appliance module by the appliance module communication circuit comprises:
means for extracting a segment of compressed real time media data from the frame of data; and
means for generating a serial signal that includes the segment chronologically sequenced amongst other segments of compressed real time media data.

4. The multi-media communication base of claim 1, wherein the appliance module support circuit further comprises:
means for translating a signal received from the appliance module communication circuit representing subscriber control of the appliance module to a frame of data compatible with a protocol recognized by the service provider.

5. The multi-media communication base of claim 4, wherein:
the means for translating a frame of data originated by the service provider to a signal compatible with transmission to the appliance module by the appliance module communication circuit comprises:
means for extracting a value of a data element from the frame of data;
means for associating the value with a data element;
means for generating a serial signal that identifies the data element and the value; and
the means for translating a signal received from the appliance module communication circuit representing subscriber control of the appliance module to a frame of data compatible with a protocol recognized by the service provider comprises:
means for extracting a value of a data element from the signal;
means for extracting identification of the data element from the signal;
means for generating a frame that includes the value and the identity of the data element.

6. The multi-media communication base of claim 4, wherein:
the means for translating a frame of data originated by the service provider to a signal compatible with transmission to the appliance module by the appliance module communication circuit comprises:
means for extracting a segment of compressed real time media data from the frame of data; and
means for generating a serial signal that includes the segment chronologically sequenced amongst other segments of compresses real time media data; and
the means for translating a signal received from the appliance module communication circuit representing subscriber control of the appliance module to a frame of data compatible with a protocol recognized by the service provider comprises:
means for extracting a value of a data element from the signal;
means for extracting identification of the data element from the signal;
means for generating a frame that includes the value and the identity of the data element.

7. The multi-media communication base of claim 4, wherein:
the housing further comprises:
a subscriber data interface comprising:
a display screen; and
subscriber input means; and
the communication base further comprises:
a subscriber interface client circuit comprising:
means for receiving a signal from the subscriber input means that identifies a remote data source;
means for directing the network communication circuit to establishing a communication session with the remote data source; and
means for translating data originated by the remote data source to signals compatible for display of the data on the display screen.

8. The multi-media communication base of claim 7, wherein:
the means for translating a frame of data originated by the service provider to a signal compatible with transmission to the appliance module by the appliance module communication circuit comprises:
means for extracting a value of a data element from the frame of data;
means for associating the value with a data element; and
means for generating a serial signal that identifies the data element and the value; and
the means for translating a signal received from the appliance module communication circuit representing subscriber control of the appliance module to a frame of data compatible with a protocol recognized by the service provider comprises:
means for extracting a value of a data element from the signal;
means for extracting identification of the data element from the signal; and
means for generating a frame that includes the value and the identity of the data element.

9. The multi-media communication base of claim 7, wherein:
wherein the means for translating a frame of data originated by the service provider to a signal compatible with transmission to the appliance module by the appliance module communication circuit comprises:
means for extracting a segment of compressed real time media data from the frame of data; and
means for generating a serial signal that includes the segment chronologically sequenced amongst other segments of compresses real time media data; and
the means for translating a signal received from the appliance module communication circuit representing subscriber control of the appliance module to a frame of data compatible with a protocol recognized by the service provider comprises:
means for extracting a value of a data element from the signal;
means for extracting identification of the data element from the signal; and
means for generating a frame that includes the value and the identity of the data element.

10. A multi-media communication management system for serving a selected one of a plurality of data appliance modules, the system comprising:
a local content server for providing information content compatible with a subscriber interface of the selected appliance module on a network media;
a base unit including:
a docking station for coupling to the selected data appliance module;
a power circuit providing operating power to the base unit and coupled to the docking station for providing operating power to the appliance module;
a network communication circuit coupled to a network medium for exchanging frames of data with the local content server over the network medium;
an appliance module communication circuit coupled to the docking bay for exchanging data with the selected appliance module;
an appliance module support circuit comprising:
means for reading a network address of the local content server from a memory stored in at least one of the base unit and the appliance module;
means for directing the network communication circuit to establish a communication session with the local content server utilizing the network address; and
means for translating a frame of data originated by the local content server to a signal compatible with transmission to the appliance module by the appliance module communication circuit.

11. The system of claim 10, wherein:
wherein the means for translating a frame of data originated by the local content server to a signal compatible with transmission to the appliance module by the appliance module communication circuit comprises:
means for extracting a value of a data element from the frame of data;
means for associating the value with a data element; and
means for generating a serial signal that identifies the data element and the value.

12. The system of claim 10, wherein:
wherein the means for translating a frame of data originated by the local content server to a signal compatible with transmission to the appliance module by the appliance module communication circuit comprises:
means for extracting a segment of compressed real time media data from the frame of data; and
means for generating a serial signal that includes the segment chronologically sequenced amongst other segments of compressed real time media data.

13. The system claim 10, wherein the appliance module support circuit further comprises means for translating a signal received from the appliance module communication circuit representing subscriber control of the appliance module to a frame of data compatible with a protocol recognized by the local content server.

14. The system of claim 13, wherein:
the means for translating a frame of data originated by the local content server to a signal compatible with transmission to the appliance module by the appliance module communication circuit comprises:
means for extracting a value of a data element from the frame of data;
means for associating the value with a data element; and
means for generating a serial signal that identifies the data element and the value; and
the means for translating a signal received from the appliance module communication circuit representing subscriber control of the appliance module to a frame of data compatible with a protocol recognized by the service provider comprises:
means for extracting a value of a data element from the signal;
means for extracting identification of the data element from the signal; and
means for generating a frame that includes the value and the identity of the data element.

15. The system of claim 13, wherein:
the means for translating a frame of data originated by the local content provider to a signal compatible with transmission to the appliance module by the appliance module communication circuit comprises:
means for extracting a segment of compressed real time media data from the frame of data; and
means for generating a serial signal that includes the segment chronologically sequenced amongst other segments of compresses real time media data; and
the means for translating a signal received from the appliance module communication circuit representing subscriber control of the appliance module to a frame of data compatible with a protocol recognized by the local content server comprises:
means for extracting a value of a data element from the signal;
means for extracting identification of the data element from the signal; and
means for generating a frame that includes the value and the identity of the data element.

16. A method of translating subscriber information content between a information content server and a selected appliance module, the method comprising:
detecting an appliance module coupled to a docking bay;
providing operating power to the appliance module;
determining a network address of an information content server that provides information content that is compatible with a subscriber interface of the appliance module;
establishing a communication session with the information content server utilizing the network address; and
translating a frame of data originated by the information content server to a signal compatible with transmission to the appliance module through the docking bay.

17. The method of claim 16, wherein:
wherein the step of translating a frame of data originated by the information content server to a signal compatible with transmission to the appliance module comprises:
extracting a value of a data element from the frame of data;
associating the value with the data element; and
generating a serial signal that identifies the data element and the value.

18. The method of claim 16, wherein:
wherein the step of translating a frame of data originated by the information content server to a signal compatible with transmission to the appliance module comprises:
extracting a segment of compressed real time media data from the frame of data; and
generating a serial signal that includes the segment chronologically sequenced amongst other segments of compresses real time media data;

19. The method of claim 16, further comprising:
translating a signal received from the appliance module communication circuit representing subscriber control of the appliance module to a frame of data compatible with a protocol recognized by the information content server.

20. The method of claim 9, wherein:
the step of translating a frame of data originated by the information content server to a signal compatible with transmission to the appliance module comprises:
extracting a value of a data element from the frame of data;
associating the value with the data element; and
generating a serial signal that identifies the data element and the value; and
the step of translating a signal received from the appliance module communication circuit representing subscriber control of the appliance module to a frame of data compatible with a protocol recognized by the information content server comprises:
extracting a value of a data element from the signal;
extracting identification of the data element from the signal; and
generating a frame that includes the value and the identity of the data element.

21. The method of claim 19, wherein:
the step of translating a frame of data originated by the information content server to a signal compatible with transmission to the appliance module comprises:
extracting a segment of compressed real time media data from the frame of data; and
generating a serial signal that includes the segment chronologically sequenced amongst other segments of compresses real time media data; and
the step of translating a signal received from the appliance module communication circuit representing subscriber control of the appliance module to a frame of data compatible with a protocol recognized by the information content server comprises:
extracting a value of a data element from the signal;
extracting identification of the data element from the signal; and
generating a frame that includes the value and the identity of the data element.
